(19) United States
(12) Patent Application Publication
(10) Pub. No.: US 2015/0256677 A1
(43) Pub. Date: Sep. 10, 2015

(54) CONVERSATION ASSISTANT

(71) Applicant: GENESYS TELECOMMUNICATIONS LABORATORIES, INC., Daly City, CA (US)

(72) Inventors: Yochai Konig, San Francisco, CA (US); Morad Ankri, San Bruno, CA (US); Vyacheslav Zhakov, Burlingame, CA (US)

(73) Assignee: GENESYS TELECOMMUNICATIONS LABORATORIES, INC., Daly City, CA (US)

(21) Appl. No.: 14/201,648

(22) Filed: Mar. 7, 2014

(51) Int. Cl. H04M 3/51

(52) U.S. Cl. CPC H04M 3/5191

(57) ABSTRACT

An apparatus includes: a processor; and memory, wherein the memory has stored thereon instructions that, when executed by the processor, cause the processor to: identify a plurality of parameters prior to initiating an interaction request; transmit the interaction request to a server to initiate an interaction with a contact center, the interaction request comprising the plurality of parameters; and receive information regarding the interaction after termination of the interaction with the contact center.

### FIELD

Embodiments of the present invention relate to the field of software for operating contact centers, in particular, software and services for assisting people in communicating with contact centers.

### BACKGROUND

Existing customer service mobile applications and web-based (e.g., web browser-based) applications are generally directed to providing self-service options to customers by supplying virtual agent technology. For example, Nuance® Nina® is a multi-channel virtual agent that can converse with users customers via text or voice. In general, these self-service options replace the need to involve human agents in relatively simple tasks.

Other mobile or web-based applications provide specialized functions specific to the particular enterprise operating these applications. For example, the United Airlines® Mobile App allows users to book flights, check-in, view flight status, seat maps, and view frequent flyer account information.

However, to complete more complex tasks, customers often prefer to interact with a human agent, because, for example, the desired functions are not available using the mobile or web application or because the process is too complex to execute.

Therefore, what is desired is a system and a method for providing higher level customer service via mobile and web-based applications in a convenient manner.

### SUMMARY

Embodiments of the present invention are directed to mobile and web-based applications to assist customers and other people in their communications with human agents at a contact center before, during, after, and between their communications interactions such as audio communication channels (e.g., telephone, voice over-IP, etc.), video communications (e.g., using WebRTC-based video communication, Google® Hangouts®, Skype®, and other video communication technologies), and text-based communication (e.g., text chat, instant messaging, text messaging, or email).

In particular, embodiments of the present invention are directed to mobile and web-based applications designed to assist the customer in, for example, reaching the right agent to solve his or her problem, receiving relevant information during the communication, asking for follow-up actions after the communication, and searching and reviewing the communications between calls.

According to one embodiment of the present invention, an apparatus includes: a processor; and memory, wherein the memory has stored thereon instructions that, when executed by the processor, cause the processor to: identify a plurality of parameters prior to initiating an interaction request; transmit the interaction request to a server to initiate an interaction with a contact center, the interaction request including the plurality of parameters; and receive information regarding the interaction after termination of the interaction with the contact center.

The parameters may include user authentication information.

The parameters may include one or more agent identifiers corresponding to agents at the contact center.

The memory may further store instructions thereon that, when executed by the processor, cause the processor to receive an estimated wait time associated with the one or more agent identifiers.

The memory may further store instructions thereon that, when executed by the processor, cause the processor to: display one or more inferred call reasons, the inferred call reasons being computed based on at least one of a prior call, a prior interaction with the contact center, and a web browsing history; and to transmit to the contact center a selected call reason from among the inferred call reasons.

At least one of the inferred call reasons may be computed by: automatically recognizing speech within the prior call to generate recognizer output; detecting phrases within the recognizer output, the phrases corresponding to at least one topic; and identifying the at least one topic as the at least one inferred call reason.

The interaction may be routed to an agent of the contact center in accordance with the selected call reason.

The interaction may be routed to an agent of the contact center in accordance with at least one of the parameters.

The interaction may include a voice communication channel.

The memory may further store instructions thereon that, when executed by the processor, cause the processor to: display a web page; and transmit a URL of the web page or a portion of the web page.

The memory may further store instructions thereon that, when executed by the processor, cause the processor to: receive, from the contact center, content associated with content of the interaction.

The memory may further store instructions thereon that, when executed by the processor, cause the processor to: transmit, to the contact center, content associated with content of the interaction.

The memory may further store instructions thereon that, when executed by the processor, cause the processor to: transmit a command to the contact center during the interaction, the command controlling an aspect of the interaction.

The command may include a request to transfer the interaction from a first agent of the contact center to a second agent of the contact center.

The command may include a complaint regarding the interaction.

The memory may further store instructions thereon that, when executed by the processor, cause the processor to: receive, from the contact center, data associated with the interaction, the data including at least one of a shared screen, a pushed web page, and a uniform resource locator.

The memory may further store instructions thereon that, when executed by the processor, cause the processor to: transmit, to the contact center, data associated with the interaction, the data including at least one of a shared screen, an image, a uniform resource locator, and a log file.

The information regarding the interaction may be a call receipt.

The information regarding the interaction may be a recording of the interaction.

The memory may further store instructions thereon that, when executed by the processor, cause the processor to transmit an annotation associated with the recording of the interaction, the annotation including text and a time index.

The memory may further store instructions thereon that, when executed by the processor, cause the processor to: mark the annotation as private to a user; and mark the annotation as viewable by the contact center.

The memory may further store instructions thereon that, when executed by the processor, cause the processor to store a recording of the interaction.

The memory may further store instructions thereon that, when executed by the processor, cause the processor to store an annotation associated with the recording of the interaction, the annotation including text and a time index.

The information regarding the interaction may include a result of a search of a transcript of the interaction.

The information regarding the interaction may include an aggregated result of a search of a first transcript of the interaction with the contact center and a second transcript of a second interaction with another contact center different from the contact center.

The memory may further store instructions thereon that, when executed by the processor, cause the processor to search a transcript of the interaction.

The memory may further store instructions thereon that, when executed by the processor, cause the processor to search a first transcript of the interaction with the contact center and a second transcript of a second interaction with another contact center different from the contact center.

According to one embodiment of the present invention, a method for processing interactions includes: identifying, on a processor, a plurality of parameters prior to initiating an interaction request; transmitting the interaction request to a server to initiate an interaction with a contact center, the interaction request including the plurality of parameters; transmitting a command to the contact center during the interaction, the command controlling an aspect of the interaction; and receiving information regarding the interaction after termination of the interaction with the contact center.

The information regarding the interaction may include a result of a search of a transcript of the interaction.

### BRIEF DESCRIPTION OF THE DRAWINGS

FIG. 1 is a system block diagram illustrating a system supporting a contact center according to one embodiment of the present invention.

FIG. 2 is a block diagram illustrating a system for providing assistance to customers in a contact center according to one embodiment of the present invention.

FIG. 3 is a diagram illustrating the flow of data within a conversation assistance system according to one embodiment of the present invention.

FIG. 4 is a screen shot of a screen displayed by a client application running on a customer end user device showing a list of inferred call reasons upon selecting an enterprise to contact according to one embodiment of the present invention.

FIG. 5A is a flowchart illustrating a method for generating a list of inferred potential call reasons according to one embodiment of the present invention.

FIG. 5B illustrates the categorization of phrases according to one embodiment of the present invention.

FIG. 5C illustrates a distribution of call reasons as calculated by a speech analytics system according to one embodiment of the present invention.

FIG. 5D is a flowchart illustrating a method 510 for generating a list of inferred potential call reasons according to one embodiment of the present invention.

FIG. 6 is a screen shot of a list of call reasons displayed by a client application running on a customer end user device upon selecting an enterprise to contact.

FIGS. 7A and 7B are screen shots of a user interface displayed by a client application running on a customer end user device for selecting an agent to be connected to and for scheduling a call back according to one embodiment of the present invention.

FIG. 8 is a flowchart illustrating a method for identifying potential agents based on a call reason and user preferences and generating a list of expected wait times for identified agents according to one embodiment of the present invention.

FIG. 9A is a screen shot of a screen displayed by a client application running on a customer end user device in which an agent is sharing content with a user according to one embodiment of the present invention.

FIG. 9B is a screen shot of a screen displayed by a client application running on a customer end user device in which shows content shared with a user by an agent during a previous conversation according to one embodiment of the present invention.

FIG. 9C is a flowchart illustrating a method for automatically generating content to be shared with a client application according to one embodiment of the present invention.

FIG. 10 is a flowchart illustrating a method for processing a request to transfer a call according to one embodiment of the present invention.

FIG. 11 is a flowchart illustrating a method for processing a complaint according to one embodiment of the present invention.

FIG. 12 is a screen shot displayed by a client application running on a customer end user device upon selecting a playback of a recording of a prior conversation according to one embodiment of the present invention.

FIG. 13A is a flowchart illustrating a method for receiving and storing annotations from a client application to annotate a call according to one embodiment of the present invention.

FIG. 13B is a flowchart illustrating a method for transmitting annotations from the conversation assistance servers to the client application according to one embodiment of the present invention.

FIG. 14 is a screen shot displayed by a client application running on a customer end user device upon selecting a recording of a prior conversation having associated annotations according to one embodiment of the present invention.

FIGS. 15A, 15B, and 15C are a screen shots displayed by a client application running on a customer end user device during a process of annotating a recorded call.

FIG. 16 is a flowchart illustrating a method for searching multiple contact centers according to one embodiment of the present invention.

FIGS. 17A and 17B are screen shots of a user interface displayed by a client application running on a customer end user device for searching call recordings and viewing search results according to one embodiment of the present invention.

FIG. 18 is block diagram of a vendor relationship management system according to one embodiment of the invention.

FIG. 19 is a screenshot of a client application providing categories of vendors that are accessible through the client application along with a search box to allow a user to enter a search query to search for a particular enterprise according to one embodiment of the present invention.

FIG. 20A is a screenshot of a user interface of a client application for entering personal profile data according to one embodiment of the present invention.

FIG. 20B is a screenshot of a user interface of a client application for controlling the data that is to be supplied to particular vendors according to one embodiment of the present invention.

FIG. 21 is a screenshot of a user interface of a client application according to one embodiment of the present invention where, upon selecting an option to contact one or more connected enterprises belonging to the same category, the user interface displays current wait times for agents at those enterprises.

FIG. 22A is a block diagram of a computing device according to an embodiment of the present invention.

FIG. 22B is a block diagram of a computing device according to an embodiment of the present invention.

FIG. 22C is a block diagram of a computing device according to an embodiment of the present invention.

FIG. 22D is a block diagram of a computing device according to an embodiment of the present invention.

FIG. 22E is a block diagram of a network environment including several computing devices according to an embodiment of the present invention.

### DETAILED DESCRIPTION

In general terms, embodiments of the present invention are directed to an application for assisting customers to communicate with one or more customer contact centers before, during, and/or after a communication session with a particular contact center. Embodiments of the present invention are also directed to an application that, in addition or in lieu of assisting customers in communicating with the customer contact centers, also allows customers to manage data associated with interactions with the various contact centers or other vendors by allowing customers to share data with other.

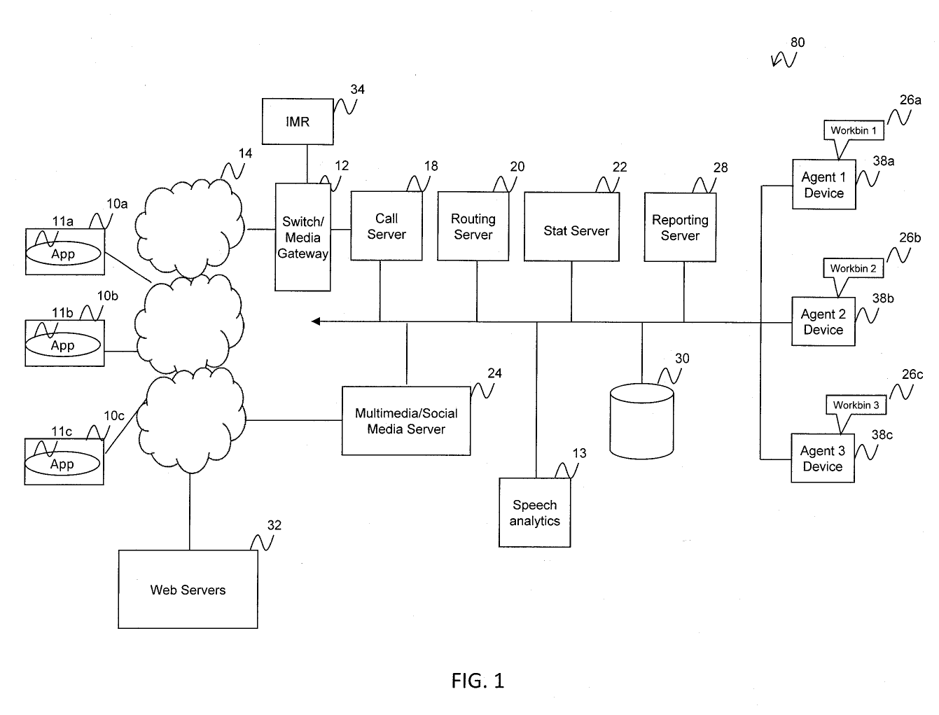

FIG. 1 is a schematic block diagram of a contact center system 80 (also simply referred to as a contact center) according to one exemplary embodiment of the invention. The contact center may be an in-house facility to a business or corporation for serving the enterprise in performing the functions of sales and service relative to the products and services available through the enterprise. In another aspect, the contact center may be a third-party service provider. The contact center may be deployed in equipment dedicated to the enterprise or third-party service provider, and/or deployed in a remote computing environment such as, for example, a private or public cloud environment with infrastructure for supporting multiple contact centers for multiple enterprises. For the sake of convenience, whether the system supporting the contact center is located in an in-house facility of an enterprise, hosted remotely as a public or private cloud system or by a third-party service provider, the various servers of the system will be referred to herein as being at the contact center.

According to one exemplary embodiment, the contact center includes resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like.

Customers, potential customers, or other end users (collectively referred to as customers) desiring to receive services from the contact center may initiate inbound calls to the contact center via their end user devices 10a-10c (collectively referenced as 10). Each of the end user devices 10 may be a communication device conventional in the art, such as, for example, a telephone, wireless phone, smart phone, personal computer, electronic tablet, and/or the like. Users operating the end user devices 10 may initiate, manage, and respond to telephone calls, emails, chats, text messaging, web-browsing sessions, and other multi-media transactions. Such communication may be, for example, via an application 11a-11c (referenced generally via reference 11) hosted by the end user device 10. The application 11 may, in addition or in lieu of the communication, allow the customer to manage relationships and data with various contact centers.

Inbound and outbound calls from and to the end users devices 10 may traverse a telephone, cellular, and/or data communication network 14 depending on the type of device that is being used. For example, the communications network 14 may include a private or public switched telephone network (PSTN), local area network (LAN), private wide area network (WAN), and/or public wide area network such as, for example, the Internet. The communications network 14 may also include a wireless carrier network including a code division multiple access (CDMA) network, global system for mobile communications (GSM) network, and/or any 3G or 4G network conventional in the art.

According to one exemplary embodiment, the contact center 80 includes a switch/media gateway 12 coupled to the communications network 14 for receiving and transmitting calls between end users and the contact center 80. The switch/media gateway 12 may include a telephony switch configured to function as a central switch for agent level routing within the center. In this regard, the switch 12 may include an automatic call distributor, a private branch exchange (PBX), an IP-based software switch, and/or any other switch configured to receive Internet-sourced calls and/or telephone network-sourced calls. According to one exemplary embodiment of the invention, the switch is coupled to a call server 18 which may, for example, serve as an adapter or interface between the switch and the remainder of the routing, monitoring, and other call-handling components of the contact center 80.

The contact center 80 may also include a multimedia/social media server for engaging in media interactions other than voice interactions with the end user devices 10 and/or web servers 32. The media interactions may be related, for example, to email, vmail (voice mail through email), chat, video, text-messaging, web, social media, screen-sharing, and the like. The web servers 32 may include, for example, social interaction site hosts for a variety of known social interaction sites to which an end user may subscribe, such as, for example, Facebook, Twitter, and the like. The web servers may also provide web pages for the enterprise that is being supported by the contact center 80. End users may browse the web pages and get information about the enterprise's products and services. The web pages may also provide a mechanism for contacting the contact center 80, via, for example, web chat, voice call, email, web real time communication (WebRTC), or the like.

According to one exemplary embodiment of the invention, the switch is coupled to an interactive media response (IMR) server 34, which may also be referred to as a self-help system, virtual assistant, or the like. The IMR server 34 may be similar to an interactive voice response (IVR) server, except that the IMR server is not restricted to voice, but may cover a variety of media channels including voice. Taking voice as an example, however, the IMR server may be configured with an IMR script for querying calling customers on their needs. For example, a contact center 80 for a bank may tell callers, via the IMR script, to “press 1” if they wish to get an account balance. If this is the case, through continued interaction with the IMR, customers may complete service without needing to speak with an agent. The IMR server 34 may also ask an open ended question such as, for example, “How can I help you?” and the customer may speak or otherwise enter a reason for contacting the contact center 80. The customer's response may then be used by the routing server 20 to route the call to an appropriate contact center 80 resource.

If the call is to be routed to an agent, the call is forwarded to the call server 18 which interacts with a routing server 20 for finding an appropriate agent for processing the call. The call server 18 may be configured to process PSTN calls, VoIP calls, and the like. For example, the call server 18 may include a session initiation protocol (SIP) server for processing SIP calls. According to some exemplary embodiments, the call server 18 may, for example, extract data about the customer interaction such as the caller's telephone number, often known as the automatic number identification (ANI) number, or the customer's internet protocol (IP) address, or email address.

In some embodiments, the routing server 20 may query a customer database, which stores information about existing clients, such as contact information, service level agreement (SLA) requirements, nature of previous customer contacts and actions taken by contact center 80 to resolve any customer issues, and the like. The database may be managed by any database management system conventional in the art, such as Oracle, IBM DB2, Microsoft SQL server, Microsoft Access, PostgreSQL, MySQL, FoxPro, and SQLite, and may be stored in a mass storage device 30. The routing server 20 may query the customer information from the customer database via an ANI or any other information collected by the IMR 34 and forwarded to the routing server by the call server 18.

Once an appropriate agent is available to handle a call, a connection is made between the caller and the agent device 38a-38c (collectively referenced as 38) of the identified agent. Collected information about the caller and/or the caller's historical information may also be provided to the agent device for aiding the agent in better servicing the call. In this regard, each agent device 38 may include a telephone adapted for regular telephone calls, VoIP calls, and the like. The agent device 38 may also include a computer for communicating with one or more servers of the contact center 80 and performing data processing associated with contact center 80 operations, and for interfacing with customers via voice and other multimedia communication mechanisms.

The selection of an appropriate agent for routing an inbound call may be based, for example, on a routing strategy employed by the routing server 20, and further based on information about agent availability, skills, and other routing parameters provided, for example, by a statistics server 22.

The contact center 80 may also include a reporting server 28 configured to generate reports from data aggregated by the statistics server 22. Such reports may include near real-time reports or historical reports concerning the state of resources, such as, for example, average waiting time, abandonment rate, agent occupancy, and the like. The reports may be generated automatically or in response to specific requests from a requestor (e.g. agent/administrator, contact center application, and/or the like).

According to one exemplary embodiment of the invention, the routing server 20 is enhanced with functionality for managing back-office/offline activities that are assigned to the agents. Such activities may include, for example, responding to emails, responding to letters, attending training seminars, or any other activity that does not entail real time communication with a customer. Once assigned to an agent, an activity an activity may be pushed to the agent, or may appear in the agent's workbin 26a-26c (collectively referenced as 26) as a task to be completed by the agent. The agent's workbin may be implemented via any data structure conventional in the art, such as, for example, a linked list, array, and/or the like. The workbin may be maintained, for example, in buffer memory of each agent device 38.

According to one exemplary embodiment of the invention, the mass storage device(s) 30 may store one or more databases relating to agent data (e.g. agent profiles, schedules, etc.), customer data (e.g. customer profiles), interaction data (e.g. details of each interaction with a customer, including reason for the interaction, disposition data, time on hold, handle time, etc.), and the like. According to one embodiment, some of the data (e.g. customer profile data) may be provided by a third party database such as, for example, a third party customer relations management (CRM) database. The mass storage device may take form of a hard disk or disk array as is conventional in the art.

According to one embodiment, the contact center may also include an analytics server 13 for analyzing real time/recorded speech/text exchanged in interactions between customers and the contact center. The analyzed data may be used, for example, to perform searches, run statistics, categorize the interactions, and/or gain understanding of the communications to better serve the customer during a current interaction and/or future interactions.

A person of skill in the art should recognize that other servers in lieu or in addition to the servers depicted in FIG. 1 may be included in the contact center. For example, the contact center may include a media server (not shown) for providing media services during an interaction, such as, for example, recording a voice call between a customer and an agent of the contact center.

The various servers of FIG. 1 may each include one or more processors executing computer program instructions and interacting with other system components for performing the various functionalities described herein. The computer program instructions are stored in a memory implemented using a standard memory device, such as, for example, a random access memory (RAM). The computer program instructions may also be stored in other non-transitory computer readable media such as, for example, a CD-ROM, flash drive, or the like. Also, although the functionality of each of the servers is described as being provided by the particular server, a person of skill in the art should recognize that the functionality of various servers may be combined or integrated into a single server, or the functionality of a particular server may be distributed across one or more other servers without departing from the scope of the embodiments of the present invention.

In the various embodiments, the term interaction is used generally to refer to any real-time and non-real time interaction that uses any communication channel including, without limitation telephony calls (PSTN or VoIP calls), emails, vmails (voice mail through email), video, chat, screen-sharing, text messages, social media messages, web real-time communication (e.g. WebRTC calls), and the like.

Embodiments of the present invention are directed to systems and methods for providing assistance to customers before, during, after, and between communications with agents at a contact center 80.

### I. Conversation Assistant

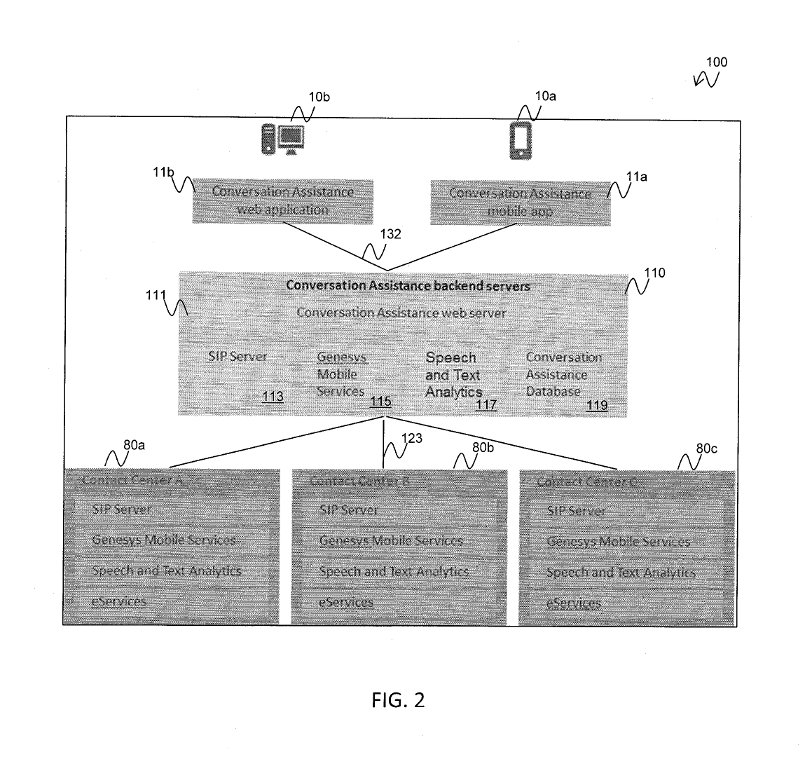

FIG. 2 is a block diagram of a conversation assistance system 100 for providing assistance to contact center customers in communicating with one or more contact centers 80a, 80b, and 80c (generically contact center 80 of FIG. 1) according to one embodiment of the invention. According to one embodiment, the contact centers 80 (also referred to as vendors) may be operated and managed by disparate enterprises that may or may not have any particular relationship with one another.

According to one embodiment, the system of FIG. 2 includes a conversation assistance server 110 coupled to the end user devices 10 over data link 132, and to the various contact centers 80 over data link 134. The data links 132, 134 may traverse the data communications network 14 of FIG. 1.

According to one embodiment, a customer accesses the conversation assistance server 110 via the client application 11 installed in his or her end user device 10 to manage conversations and/or data with the contact centers 80. In this regard, the client application 11 provides a front-end user interface to the user. In the embodiment where the client application Ila is a mobile application, the application may be implemented in any of a variety of languages (e.g., C, Objective C, Java, HTML and JavaScript, etc.) and may operate on any of a variety of operating systems and software platforms (e.g., Apple® iOS, Android®, Microsoft® Windows Mobile®, Microsoft Windows®, Apple® OS X®, etc.). In the embodiment where the client application 11b is a web application, it may be configured to in a web browser of, for example, a laptop computer, a desktop computer, or a tablet computer.

In some embodiments of the present invention, the conversation assistance servers 110 may include one or more servers typically found in customer contact centers such as, for example, a web server 111, a SIP server 113, a mobile services server 115, a speech and text analytics server 117, and a conversation assistance database 119. The various servers are invoked for providing data and services to the client applications 11, and communicating with the contact centers 80 on behalf of the customer or user.

According to one embodiment, the client applications 11 communicate directly only with conversation assistance servers 110, and the conversation assistance servers communicate with the servers of the contact centers 80, such as, for example, the servers depicted in FIG. 1. The conversation assistance servers 110 may also be configured to route conversations between the user and the call center using, for example, session initiation protocol (SIP) or other voice-over-IP systems, the public switched telephone network (PSTN), and/or real-time transport protocol (RTP). In addition, according to one embodiment of the present invention, communications between various components occur over hypertext transfer protocol (HTTP) or hypertext transfer protocol secure (HTTPS).

According to one embodiment of the present invention, the conversation assistance servers 110 communicate with various servers associated with the contact center. For example, the conversation assistance servers 110 may communicate with speech and text analytics servers 13 of the contact center to retrieve transcriptions of prior calls and may communicate with a multimedia/social media server 24 of the contact center to initiate chat conversations between the user and an agent in the contact center. Other types of information such as availability of specific agents, estimated wait time, and call back services can be provided to the conversation assistance servers 110 using, for example, APIs such as the Genesys® Platform SDK.

Although the embodiment shown in FIG. 2 depicts interactions with a contact center system 80 as shown in FIG. 1, embodiments of the present invention are not limited thereto and may be used in other environments and within systems having a different architecture. For example, in some embodiments the conversation assistance system 100 is deployed and operated on-site with other call center applications. In other embodiments, the conversation assistance servers 110 are cloud-based and operate on a software-as-a-service (SAAS) model. In either case, the contact centers 80 may be cloud based or may be operated on site by the enterprises.

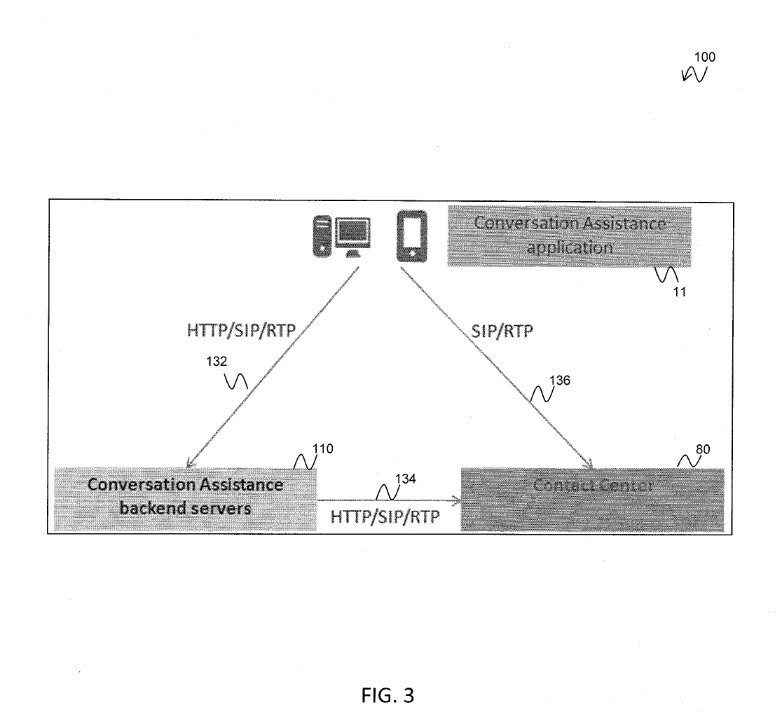

FIG. 3 is a diagram illustrating the flow of data within a conversation assistance system 100 according to one embodiment of the present invention. Referring to FIG. 3, user interactions performed with a particular call center 80 (e.g., navigating menus) are generally done directly with a specific call center. As such, according to some embodiments of the present invention, conversation assistance servers 110 merely forward (or route) requests received from the client applications 11 to the contact centers 80 and forward responses from the contact centers 80 to the client applications 11 over connections 132 and 134 that may use protocols such as HTTP, SIP, and RTP.

In other embodiments, in addition to routing, the conversation assistance servers 110 transform the requests and responses between the client applications 11 and the contact centers 80. For example, the conversation assistance servers 110 may be configured to modify or otherwise reformat data pushed from the contact centers 80 to a format more appropriate for the particular devices that the client applications 11 are running on (e.g., smartphones versus larger screened devices such as tablets and laptop computers or the speed of the Internet connection between the device and the conversation assistance servers 110).

In some cases where quick responsiveness is desired (e.g., during a call with a contact center), communications occur directly between the client application 11 and the contact center 80 over connection 136, e.g., when communicating using SIP and RTP.

According to one embodiment of the present invention, the conversation assistance servers 110 provide a number of functions to a user via the client applications 11 before a call (e.g., during a “pre-call” period). These functions include, without limitations, customer authentication, call reason, identification, agent selection, and call back management.

In one embodiment, conversation assistance servers 110 assist in customer authentication by receiving (and possibly storing) credentials from a user and transmitting the credentials to the contact center 80. For example, a user may input name, address, and account number information into a client application 11 which forwards the credentials to the contact center 80, thereby reducing errors from inaccuracy in conveying the authentication information and streamlining the initial customer authentication portion of the call (e.g., supplying a “mother's maiden name” or other password).

According to one embodiment of the present invention, the conversation assistance servers 110 or the client application 11 store the user's credentials. These credentials may include authentication tokens issued by the various organizations, passwords, addresses and other contact information, etc. These stored credentials may be automatically transmitted to various contact centers 80 by the client application or the conversation assistance servers 110. In addition, the client application 11 allows a user to control which portions of the stored credentials can be sent to various enterprises.

For example, the stored credentials may include a user's address, bank account number, frequent flier number, credit card number, and phone number. As such, the user may be willing to share his or her frequent flier number and credit card number with an airline company, but would not be willing to share his or her bank account number with the airline company. As such, embodiments of the present invention allow a user to granularly select which portions of the stored credentials or information can be accessed by each enterprise that is compatible with the conversation assistance system 100.

In a traditional interactive voice response (IVR) menu system, a user (or a customer) navigates through menus to select a broad call reason (e.g., “For sales inquiries, press 1. For customer support, press 2 . . . . ”) in addition to selecting a language. In one embodiment, the client application 11 stores customer preferences such as language and preferred (or “favorite”) agents and transmits these preferences to the contact center 80, thereby allowing the user to be routed to an appropriate agent more quickly.

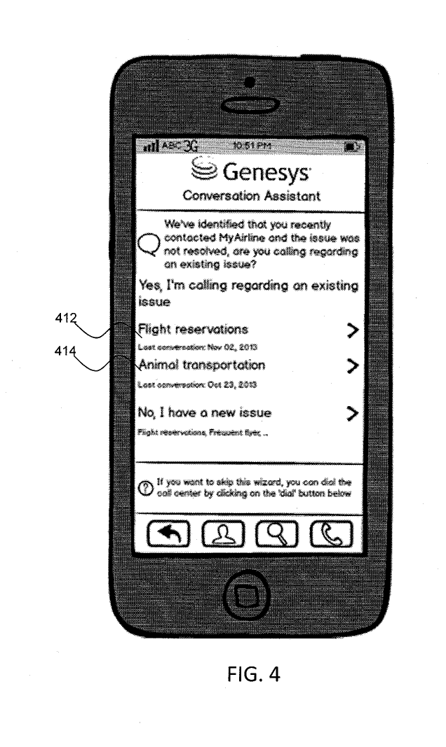

FIG. 4 is a screen shot of a screen displayed by a client application running on a customer end user device showing a list of inferred call reasons upon selecting an enterprise to contact (e.g., a particular company or organization) according to one embodiment of the present invention. As seen in the example of FIG. 4, two call reasons 412 and 414 are inferred by the conversation assistance servers 110 (“flight reservations” and “animal transportation”). As shown in FIG. 4, timestamps associated with the last conversation related to that topic are shown. In addition, the user interface provides an option to select a new issue.

In one embodiment, the reason for the current call can be inferred using a variety of information including the user's previous call (if any), prior interactions with the enterprise, information collected from the user's interactions with the enterprise's website, and prior communications using other modalities (e.g., chat, email, prior purchases, etc.).

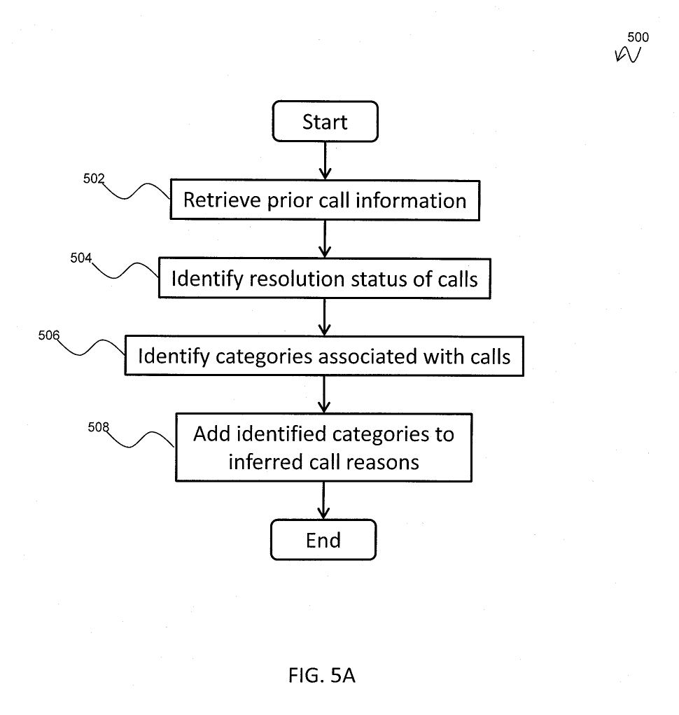

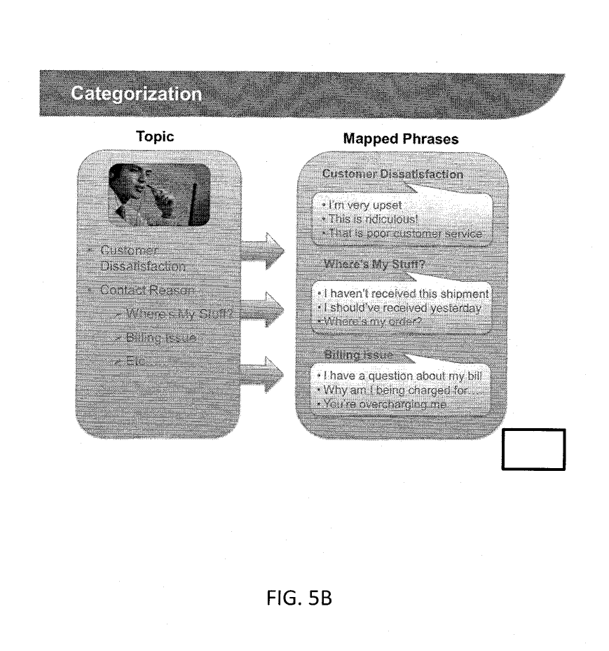

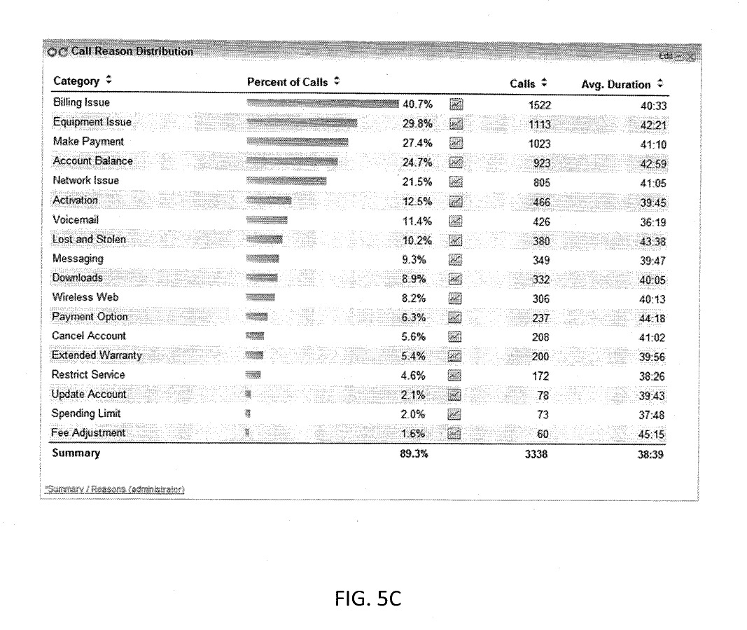

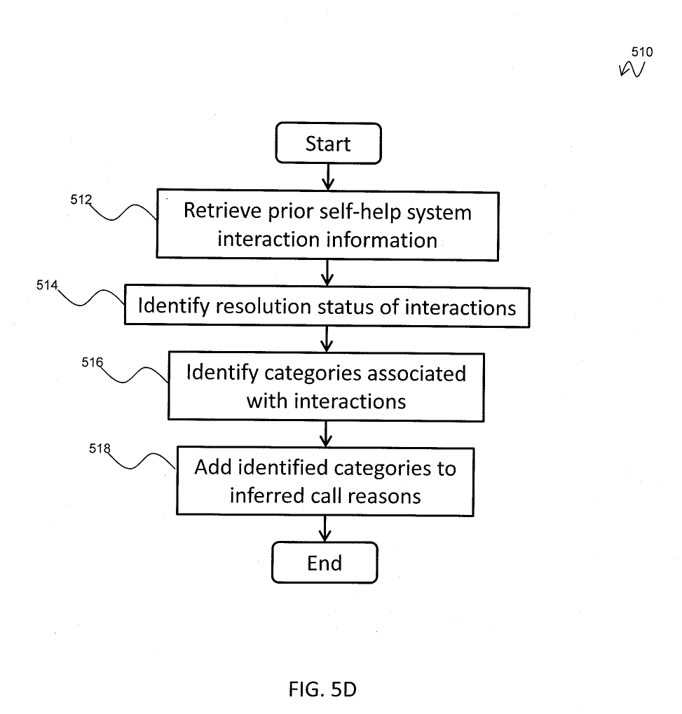

FIG. 5A is a flowchart illustrating a method 500 for generating a list of inferred potential call reasons according to one embodiment of the present invention. Referring to FIG. 5A, according to one embodiment of the present invention, in operation 502 the conversation assistance servers 110 retrieves information stored by the contact center 80 to determine whether the prior call (if any) was resolved or not. For example, the information may be stored in a speech analytics system 13 of the contact center 80 or a speech analytics system 113 of the conversation assistance servers 113. According to one embodiment, the information is stored in the user's end user device. More information regarding the automatic analysis of speech and categorization of interactions with a contact center can be found, for example, in U.S. Pat. No. 7,487,094 “System and method of call classification with context modeling based on composite words,” the entire disclosure of which his incorporated herein by reference.

FIG. 5B illustrates the categorization of phrases according to one embodiment of the present invention and FIG. 5C illustrates a distribution of call reasons as calculated by a speech analytics system according to one embodiment of the present invention.

For example, if the previous call included the phrase “How do I program my DVR from my mobile phone?” and the agent answers “I can't help you with this, you might want to visit the website,” a speech analytics system 13 can analyze the conversation, determine that the call was not resolved, and categorize the call accordingly. Based on this category (or “topic”) information, a conversation assistance server 110 can access the speech analytics system 13 in operation 504 to retrieve information that the prior call was categorized as unresolved, receive information in operation 506 regarding other categories associated with the call (e.g., “DVR support”), and include “DVR customer support” as a potential inferred call reason. As such, embodiments of the present invention can use the categories that were automatically assigned by the speech analytics system 13 to the previous call in order to automatically determine whether the current call is likely to relate to a prior unresolved issue and to add these suggestions as to inferred potential call reasons in operation 508.

In some embodiments of the present invention, a user can use the client application 11 to mark a call as being unresolved. If the user calls again within a particular time period (e.g., 30 minutes), the system can infer that the user is likely calling again on the same issue.

According to one embodiment of the present invention, the user can flag or mark a conversation as being “resolved” or “unresolved” (or, equivalent terms such as “complete” or “incomplete”) based on his or her understanding of the circumstances. In addition, the speech analytics systems according to embodiments of the present invention can automatically detect whether an issue has been resolved or not based on the detection of phrases within the recognized speech (e.g., “Thank you, my phone is working again.”). However, there may be instances in which the user's perception of the resolution status may differ from that of the contact center (e.g., due to an error in the automatic speech recognition determination, due to a changing of the user's mood, due to changing conditions with the product, etc.).

As such, in some embodiments of the present invention, the resolution status of the call is synchronized between the contact center 80, the conversation assistance server 110, and the client application 11. For example, the synchronization process may include, for example: synchronizing based on newest timestamp; deferring to manually entered status settings (e.g., allowing the user or an agent's entries to automatically override the determinations of automatic speech recognition systems); or other synchronization techniques as would be known by a person of ordinary skill in the art.

According to another embodiment of the present invention, a call reason can be inferred from a self-help system operating, for example, on a website of the enterprise. FIG. 5D is a flowchart illustrating a method 510 for generating a list of inferred potential call reasons according to one embodiment of the present invention. Such a self-help system includes “virtual personal assistants” (or conversational agents) designed to simulate conversation with a human agent by parsing freeform text requests from a user (e.g., “Am I eligible for an upgrade on my mobile phone?”) and generating responses based on those parsed requests. One example of such a self-help system is Nuance® Nina.

Generally, self-help attempts are “escalated” to a live agent. However, before routing takes place, information about the user is inferred from the interaction with the self-help system. For example, in response to the question “Am I eligible for an upgrade on my mobile phone?” the agent may reply “To answer this question, you need to speak with an agent, would you like me to connect you now?” The interaction may also be tagged with the “upgrade eligibility” category or topic. If the user answers “yes,” then the interaction may be tagged with the “unresolved” category because the self-help virtual agent was unable to resolve the user's issue. In operation 512, the conversation assistance server 110 retrieves information about the interaction with the self-help system (e.g., either during or after the interaction). In operation 514, the conversation assistance server 110 determines whether or not the interaction has been resolved and, in operation 516, identifies categories associated with the interaction. In the above example, the pending call should be routed with the call reason “upgrade eligibility” and, in operation 518, the conversation assistance server 110 adds the identified call reason to the inferred call reasons.

In some embodiments of the present invention, every mode of self-help (e.g., website, Speech Enabled IVR, Virtual Agent App, etc.) involves user authentication. Therefore, a CUSTOMER ID, or any other indicia for identifying the customer, is associated with each of these interactions. In these embodiments, when the user invokes a pre-call option in his conversation assistance client application 11, the client application communicates with the conversation assistance servers 110, which analyze the user's last interactions as identified by CUSTOMER ID. If those interactions include interactions with the self-help system and if the issue was unresolved, the conversation assistance servers 110 communicate with the client application 11 to display as a potential call reason, the customer question/problem that was unresolved in the user's recent self-help session.

In still other embodiments of the present invention, interactions with enterprises over a variety of other channels (e.g., web, email, chat, phone, customer service mobile applications, retail shops, and social media channels) are also analyzed to identify the issue that may need to be resolved. One example, of such a product for analyzing data from a wide range of different channels is Genesys® Text Analytics.

For example, if a customer extensively visits web pages that relate to “flying with pets policy” and then used the client application 11 to engage in a call with a contact center 80, the conversation assistance server 110 may infer that the user is interested in speaking with an agent regarding airline policies on traveling with animals and identify that topic as a possible call reason.

In addition, in some embodiments, if a user would like to initiate a call from a specific web page by activating a “click to call” button and the user has a conversation assistance client application 11 installed, then the conversation assistance client application may open in the same window or a new browser window, the current web page (e.g., its URL) may be suggested as a call reason or shared with the agent, and the user may mark portions of the currently open web page to be shared with the agent (e.g., highlighting particular paragraphs) or they can initiate a co-browsing session with WebRTC or similar communication technologies, see for instance Genesys® WebRTC system. For example, in one embodiment in which the end user device 10 runs the Android® operating system, the Android “share intent” can be used to share particular web pages with a conversation assistance client application 11 running on end user device 10, thereby automatically sharing the current link with the client application 11.

According to one embodiment, the client application 11 also provides an option for the case where none of the inferred call reasons corresponds to the user's actual reason for calling. Upon selecting this option, the client application 11 displays a list of all available call reasons as either a flat list or in a hierarchical fashion. According to one embodiment, the user indicates his selection of a call reason, either by the user interacting with the client application 11 by pointing and clicking, or by speaking in natural voice to the client application 11.

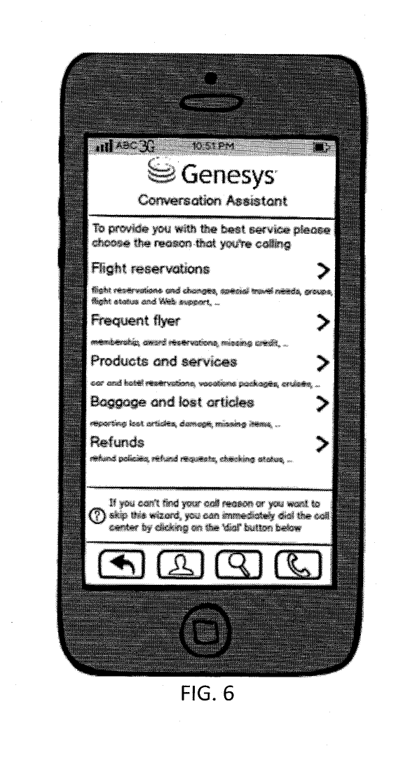

FIG. 6 is a screen shot of a list of call reasons displayed by a client application running on the customer end user 10 device upon selecting an enterprise to contact (e.g., a particular company or organization), according to one embodiment of the invention. After a user has selected a call reason using the client application 11, according to one embodiment, the selected call reason is sent to the conversation assistance server 110. The conversation assistance server 110 then computes and offers options based on, for example, user status information (e.g., premium or standard customer support tiers), the supplied call reason, and/or the current status of the call center.

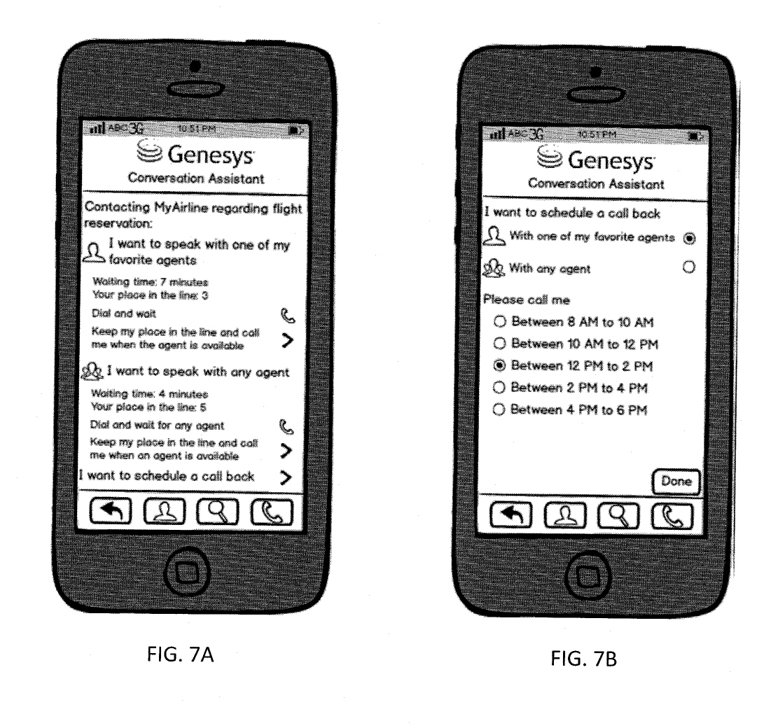

FIGS. 7A and 7B are a screen shots a user interface displayed by the client application 11 running on the customer end user device 10 for selecting an agent to be connected to and for scheduling a call back according to one embodiment of the present invention. As shown in FIGS. 7A and 7B, the options returned by the conversation assistance server 110 may include waiting for any qualified agent, waiting for one an agent on the user's list of favorite agents, receiving a call back as soon as possible from a favorite agent or any qualified agent, and receiving a call back during particular time windows.

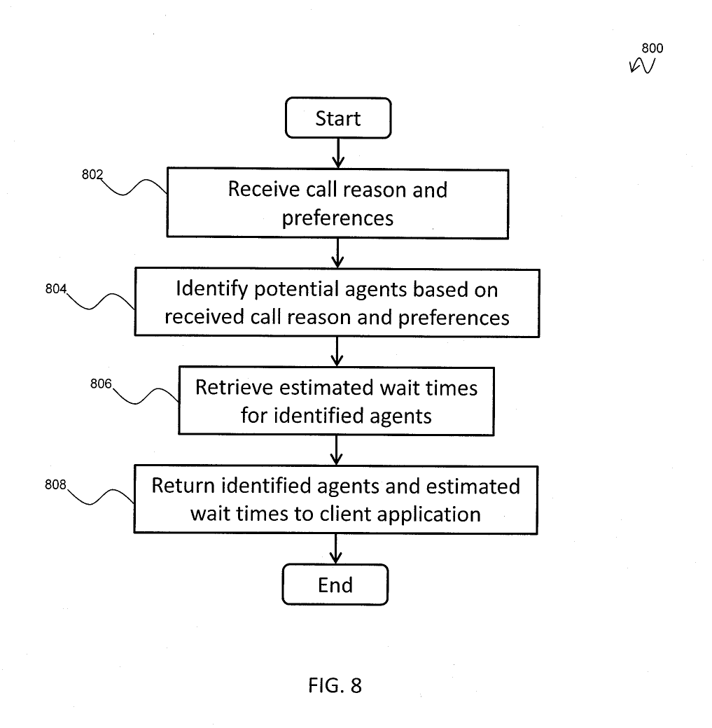

FIG. 8 is a flowchart illustrating a method for identifying potential agents based on a call reason and user preferences and generating a list of expected wait times for identified agents according to one embodiment of the present invention. Referring to FIG. 8, in operation 802, the conversation assistance server 110 receives a call reason and user preferences from the client application 11. The user preferences may include, for example, a preferred language (e.g., English, Spanish, Mandarin Chinese, Cantonese, Vietnamese, etc.) and a list of favorite agents. The conversation assistance server 110 supplies the call reason and user preferences to an appropriate mechanism of the contact center 80, such as, for example, the routing server 20, to identify, in operation 804, potential agents who have the proper skills to address the supplied call reason (e.g., customer support for particular product lines, sales, etc.) and meeting the user's preferences (e.g., language capabilities of the agents). The wait times for the identified agents are retrieved in operation 806, and the identified agents and the estimated wait times are returned to the client application 11 in operation 808. The wait times may be calculated according to conventional mechanisms based on real time availability information provided by, for example, the statistics server 22. In some embodiments, the estimated wait times for each agent (or any agent) on the list of favorite agents is retrieved along with an estimated wait time for any next available agent. In other embodiments, the estimated wait times for each individual agent in retrieved.

As shown in the embodiment of FIG. 7A, the estimated wait times for favorite agents and “any agent” are displayed in the client application 11 and the user can, by interacting with the client application, transmit a command to the server 100 indicative of the user's choice between speaking with a favorite agent or any agent. The user may also select between dialing in and waiting until it is his or her turn, receiving a call back when an agent is available, or scheduling a call back. Operations to schedule a call back are well known to persons of ordinary skill in the art and may vary based on the system and architecture of the contact center. For example, in one embodiment, the conversation assistance server 110 receives a request for a call back from at a particular time and adds a task to an agent's workbin 26 at the contact center 80, where the task requests that the agent call the user at a requested time.

According to one embodiment of the present invention, the conversation assistance servers 110 provide a number of functions to a user via the client applications 11 during a call, allowing the end user to be in control of the conversation as the call is taking place. These functions may include, without limitation, contextual help through the sharing of content from agents at the contact center, the upload of data from the user to the agent at the contact center, requests to be transferred to other agents, requests for assistance from a supervisor, and reporting complaints.

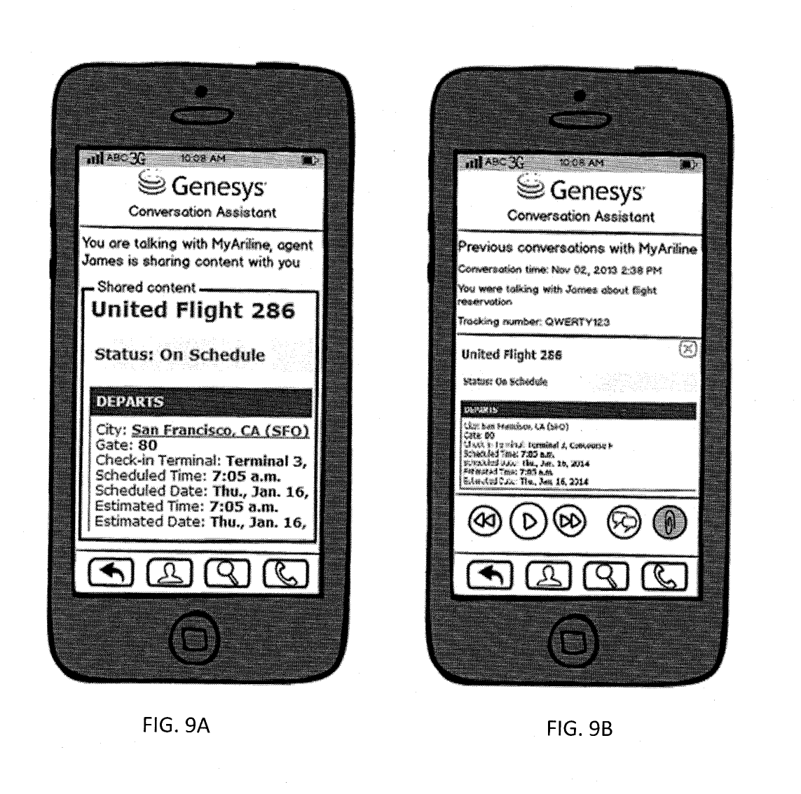

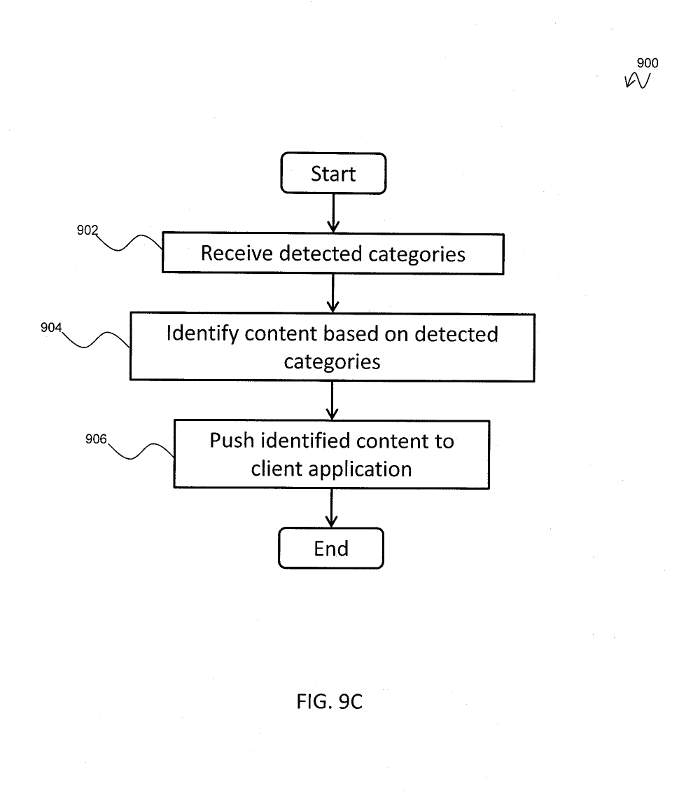

Embodiments of the present invention allow a user to receive, via the client application 11, relevant contextual content during a conversation with an agent of the contact center. FIG. 9A is a screen shot of a screen displayed by a client application running on a customer end user device in which an agent is sharing content with a user according to one embodiment of the present invention. FIG. 9B is a screen shot of a screen displayed by a client application running on a customer end user device in which shows content shared with a user by an agent during a previous conversation according to one embodiment of the present invention. The source of the content may include, for example, an agent sharing his or her screen with the user (see, e.g. FIGS. 9A and 9B), content that is manually pushed by an agent to the user's client application 11 (e.g., instructions for performing a specific operation such as resetting a malfunctioning router, a uniform resource locator or URL of a web page, etc.), and automatically generated content.

Systems and methods for sharing content between agents and users are described in, for example, U.S. patent application Ser. No. 13/669,288, “Out-of-band communication system for contact centers,” filed in the U.S. Patent and Trademark Office on Nov. 5, 2012, the entire disclosure of which is incorporated herein by reference.

FIG. 9C is a flowchart illustrating a method 900 for automatically generating content to be shared with a client application according to one embodiment of the present invention. Regarding the automatically generated content, according to one embodiment, the conversation between the user and the agent can be automatically recognized by a real-time speech analytics system 13, which transcribes the conversation. The transcript of the conversation can then be automatically analyzed by the speech analytics system 13 for keywords and be assigned categories or (“topics”). According to one embodiment, the conversation assistance server 110 receives the detected categories from the speech analytics system 13 in operation 902. In another embodiment the Real-Time Speech analytics system classifies the call by using Phrase Recognition Technology such as one described in U.S. Pat. No. 7,487,094 “System and method of call classification with context modeling based on composite words”. The detected categories are used to identify content related to those categories by consulting a Knowledge Management system such as Oracle® RightNow Knowledge Cloud Service in operation 904. This identified content can be automatically pushed to the user's client application 11 in operation 906.

For example, when discussing a malfunctioning router, the transcription output of the real-time speech analytics system 13 may detect when the user says the model number of the router and categorize the conversation as being related to a particular model. The conversation assistance server 110 may then detect the categorization of the conversation as being related to that router and automatically push product information to the client application 11, where the product information may include, for example, specifications about the router, troubleshooting guides, and software/firmware updates related to that particular router. In some embodiments, the pushed data may include a uniform resource locator (URL) identifying a web page or other resource (e.g., a file on an FTP site), text (such as web page including HTML), or may be binary data (such as images, audio, and video).

In addition, users may use the client application 11 to upload data to the contact center 80 via the conversation assistance server 110. For example, rather than asking a user to read a long serial number from a malfunctioning device to the agent, an agent may ask a user to take a photo of the relevant sticker using the camera attached or integrated into the end user device on which the client application 11 is running. Other data that can be sent to the agent may include sending error logs, credit card information, photographs of receipts as proof of purchase. In some embodiments, WebRTC data communication technology is utilized for this functionality.

According to some embodiments of the present invention, the client application 11 includes a feature to request that the call be transferred from the current agent to another agent, to a supervisor, or to request a supervisor to join the call without requiring interaction from the current agent. In some embodiments of the present invention, the request is provided from the client application 11 to the conversation assistance servers 110, which sends an appropriate request to the call center (e.g., to a call routing server or other component of the call center for performing a call transfer or conferencing operation).

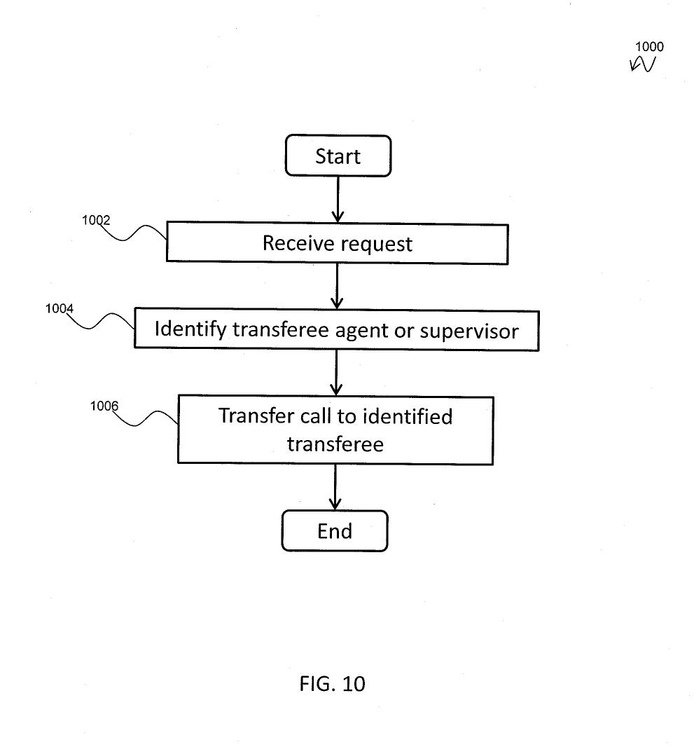

FIG. 10 is a flowchart illustrating a method 1000 for processing a request to transfer a call according to one embodiment of the present invention. In operation 1002, the conversation assistance server 110 receives from the client application 11, a transfer request. The request may be transmitted in response to the customer selecting, for example, a transfer option displayed by the client application. The transfer request may identify, based on the particular option selected by the user, whether the user would like to be transferred to another agent, be transferred to a supervisor, or have a supervisor join the call. Based on the received request, the conversation assistance server 110 may identify an agent or supervisor appropriate for the transfer (e.g., by accessing agent and supervisor availability information at the contact center 80), and initiate the call transfer or call conferencing operation to the identified agent or supervisor by sending an appropriate message to the contact center 80. For example, agent availability information may be exposed to the server 110 via protocols such as, for example, the SIMPLE SIP protocol. In response to determining that an appropriate agent is available, the SIP server 113 hosted by the conversation assistance server 110 may be configured to, for example, transmit a request to transfer the call to the specified agent. The request may be, for example, a SIP Refer request, and may include information about the call such as, for example, information on the customer (e.g. customer number), party being transferred to, and the like. In response to the request, the call server 18 at the contact center 80 may be configured to generate a call object, attach the received call data to the call object, and transmit a call request to the party being transferred to. In response to the party accepting the request, a voice communication ensues between the customer and the accepting party.

According to one embodiment, the current agent with whom the customer is communicating may be alerted of the fact that the customer has opted to transfer the call to another agent. For example, the conversation assistance server 110 may transmit a message to the agent device for display thereon.

According to one embodiment, the customer may also initiate a complaint, via the client application 11, during a current call.

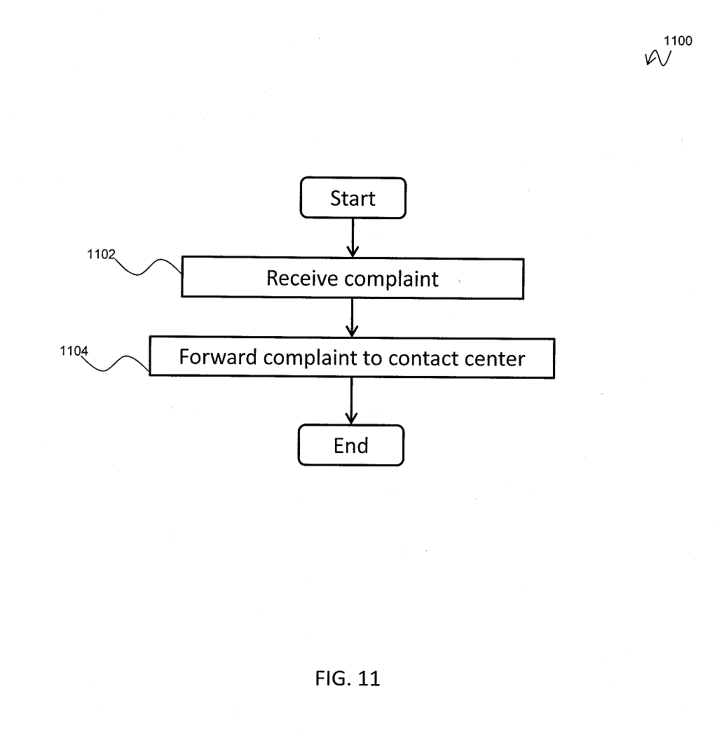

FIG. 11 is a flowchart illustrating a method for processing a complaint according to one embodiment of the present invention. The customer invokes the client application 11 during the call to report a problem with the current call (e.g., the agent's use of a racial slur during the call). In this regard, the customer may select an option provided ty the client application 11 to initiate a complaint. In response to the user selection, the client application 11 may be configured to prompt the user for optional data to attach to the complaint. For example, the user may, in response to the prompt, identify a general subject matter of the complaint, and/or attach a recording of a portion (or the entirety) of the current call to the complaint. The complaint may also be accompanied by a transcription of the call as generated by the speech analytics system 13 or 113. The client application transmits the complaint in response to detecting a user selection of a submit option.

In operation 1102, the complaint is received by the conversation assistance server 110 and forwarded to appropriate components of the contact center 80 in operation 1104. For example, the complaint may be forwarded to a database of call problems, an email inbox of a responsible person at the enterprise, or an agent workbin 26. According to one embodiment, the server 110 may be configured to receive the complaint, and process the complaint to generate an outbound communication based on rules associated with handling complaints. For example, the rules may prompt the server 110 to generate a task for an agent to review the complaint and take action in response to the complaint.

According to one embodiment of the present invention, the conversation assistance servers 110 provide a number of functions to a user via the client applications 11 after a call or between calls (e.g., not immediately before or after a given call). These features include requesting a call back, marking an issue or call as being unresolved, rating calls, adding and removing agents from the favorite agents list, listening to and commenting on recordings of calls, and searching recorded calls.

The call back request feature of the client application 11 provides an option that the user may select to request a supervisor, specialist, or other agent of the contact center to call back at a particular time or as soon as possible. According to one embodiment, the conversation assistance server 110 receives the request and generates a task that is delivered, for example, to the workbin 26 of an appropriate agent at the contact center 80.

According to one embodiment, the client application 11 provides an option that the user may select to mark previous calls (including the most recent call) as having unresolved issues. The marking of a call as unresolved may also include text, images, and other data supplied by the user that can be used, for example, to explain why the issue is still unresolved. In one embodiment, the received data and the flagging of the call as being unresolved are stored in a database connected to the conversation assistance server 110.

According to one embodiment, the client application 11 provides an option that the user may select to rate previous calls (including the most recent call). In some embodiments, the rating is a simple thumbs up/thumbs down or positive/negative rating. In other embodiments, the rating is a numerical rating (e.g., from 1 to 10). In still other embodiments the rating may be accompanied by a text description. The client application 11 may also provide a feature to share call ratings over social media (e.g., Facebook®, LinkedIn®, and Twitter®). In some embodiments of the present invention, the ratings of the agents are stored in the conversation assistance backend servers 110 and are made public to other users of the client application 11 on other end user devices 10, thereby allowing users to collaborate in identifying more helpful agents and for sharing tips on ways to obtain better service from the enterprises.

According to one embodiment, the client application 11 provides an option that the user may select to add and remove agents from a favorite agents list. For example, if a user had a positive experience with a particular agent and wanted to speak with that agent in the future, the user can utilize the client application 11 to add the agent who handled a previous interaction to the user's favorite agent list. As described above, when the client application 11 is invoked to initiate a conversation with the enterprise, the favorite agent list can be accessed and the user may be provided with the option to speak with one of their favorite agents. In addition, embodiments of the present invention also allow a user to remove agents from their favorite agent list. The favorite agent list may be stored either on the end user device 10 by the client application 11 or may be stored at the conversation assistance server 110.

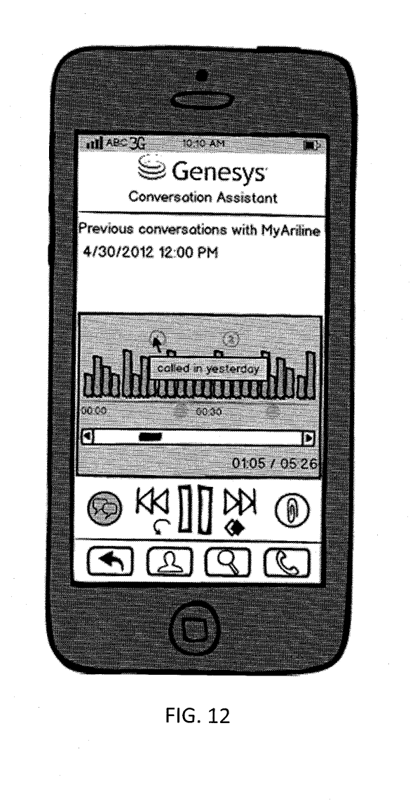

According to one embodiment, the client application 11 provides an option that the user may select to play back recordings of prior calls with contact centers 80. FIG. 12 is a screen shot displayed by the client application 11 upon selecting a playback of a recording of a prior conversation according to one embodiment of the present invention. These calls may include calls placed using the client application 11 in addition to other calls associated with the user (e.g., calls made from the same account or from the same phone number to various different contact centers running compatible or the same conversation assistance servers 110). In some embodiments, the call recordings may be stored locally on the end user device 10, on the conversation assistance servers 110, and/or at the contact centers 80. The playback might include playing back the data (shared content) that was presented via the client application 11 to the user during the call.

According to one embodiment, the client application 11 also provides records of prior calls and other interactions (including text chat transcriptions, emails, annotations and other notes regarding prior conversations) between the user and each of the connected contact centers 80. These interactions may be stored at the contact centers 80 and made available to the conversation assistance servers 110 using an application programming interface (API) or may be stored by the conversation assistance servers 110.

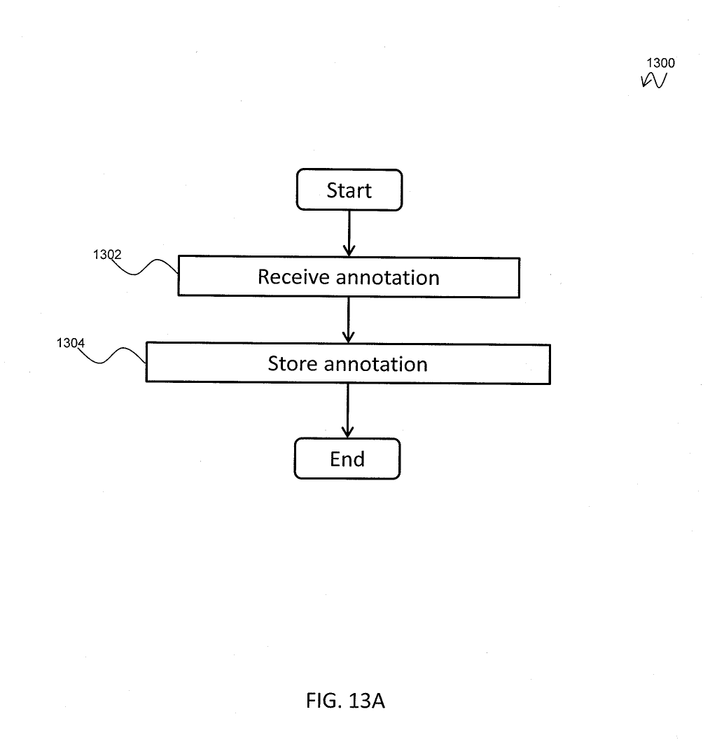

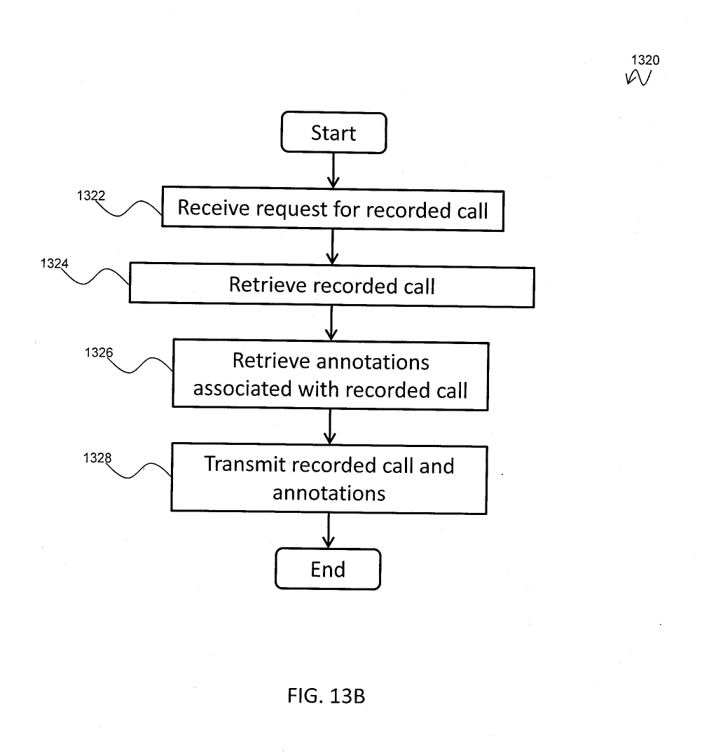

According to one embodiment, the client application 11 provides an option that the user may select to annotate the recordings of the prior calls at particular times (e.g., to note that an agent provided helpful instructions beginning at a particular time). In some embodiments, the playback material includes content that was pushed by the agent or by the user. FIG. 13A is a flowchart illustrating a method 1300 for receiving 1302 and storing 1304 annotations from a client application 11 to annotate a call according to one embodiment of the present invention. The received annotations may be stored in an annotation database of the end user device 10, call assistance server 110, and/or the contact center 80. The received annotations may include the text of the annotation along with a time index corresponding to the time within the call that the annotation is associated with. The time index may be a single point in time (e.g., a number of seconds) or may include start and end times.

FIG. 13B is a flowchart illustrating a method 1320 for transmitting annotations from the conversation assistance servers 110 to the client application 11 according to one embodiment of the present invention. The annotations received from the client application 11 may be stored in a database and may be indexed by an identifier associated with a recorded call (or “callID”). When a request for a recorded call is received by the conversation assistance server 110 in operation 1322, the recorded call is retrieved in operation 1324 from a call recording server (e.g., in the contact center 80). In addition, the stored annotations that are associated with the requested call (e.g., tagged with the callID of the requested recorded call) are also retrieved from the annotation database in operation 1326 and the retrieved recorded call and annotations are transmitted to the client application 11 in operation 1328.

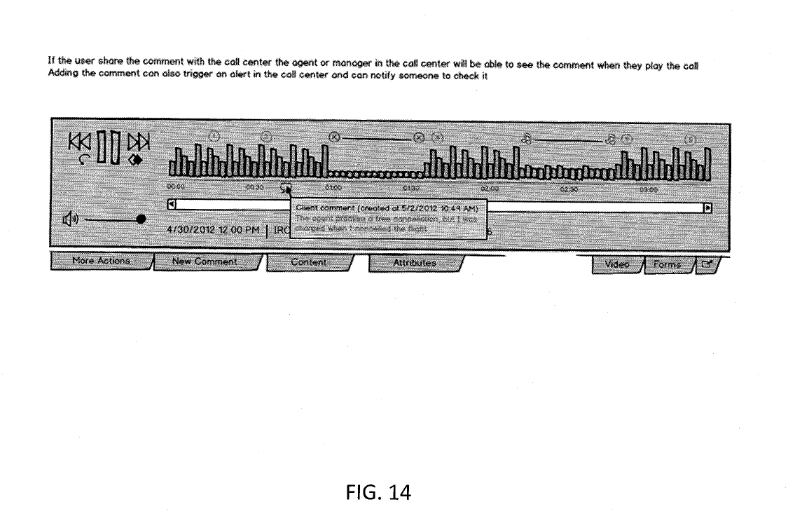

FIG. 14 is a screen shot displayed by a client application running on a customer end user device upon selecting a recording of a prior call having associated annotations according to one embodiment of the present invention. The user can potentially choose whether his or her comments are private (e.g., only to be displayed to the user via the client application 11), to be shared with the enterprise only, (e.g., to be shared with the enterprise personnel when they review the call), or to be public (e.g., shared with the enterprise and other users of the client application 11 who may interact with the enterprise). An enterprise can define a business process when user public comments would trigger a work item for enterprise personnel to review the shared comments. In addition, public comments allow users to communicate reviews and tips to other users to assist in developing

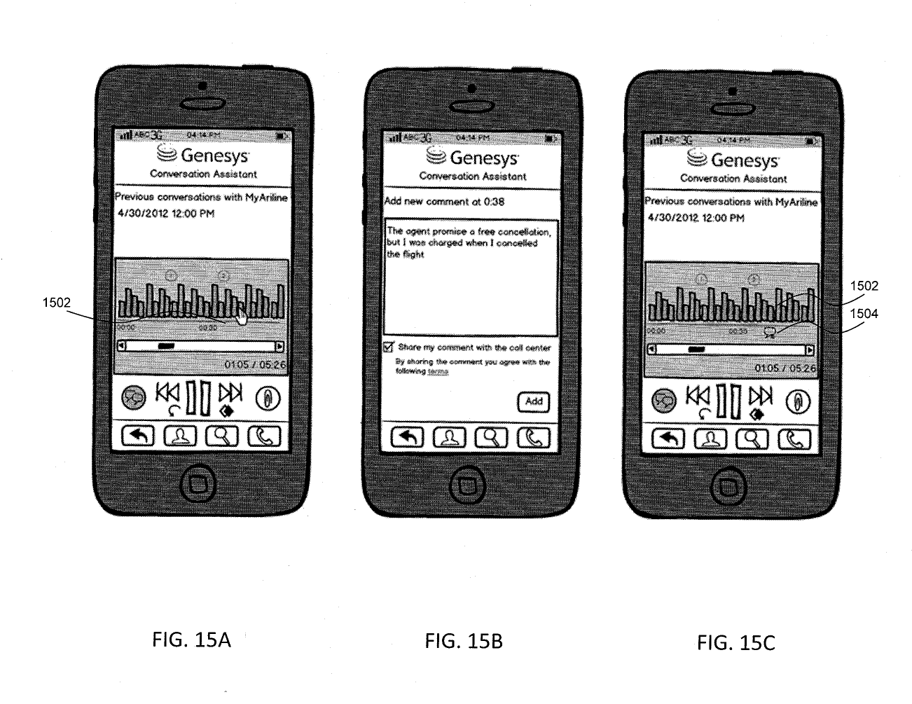

FIGS. 15A, 15B, and 15C are a screen shots displayed by a client application running on a customer end user device during a process of annotating a recorded call. FIG. 15A depicts a recorded call displayed, where a user may select a particular point in the call 1502 to add an annotation. FIG. 15B depicts a user inputting a comment at the selected particular point 1502 in the call. FIG. 15C depicts an annotated call in which the particular point 1502 includes an icon 1504 indicating the presence of an annotation in the recorded call.

According to one embodiment, the client application 11 provides a function to view a “receipt” including the name of the agent, the time of the call, and other information (e.g., a transaction number, a ticket number, a price quote, etc.) The receipt may include clickable links for additional information such as package tracking information, support ticket status information, or may link to various portions of the website of the enterprise.

Embodiments of the present invention may also provide the ability to search previously recorded calls. These searches may be performed between calls (e.g., not immediately before or after a given call) and may involve operations that are not specific to any particular call. Various call centers may include speech analytics technology (e.g., the ability to perform automatic speech recognition (ASR) on the call between the user and the agent and to analyze the resulting data) to provide further insight into the activities of the contact center. The transcriptions of the calls may be indexed by a search engine.

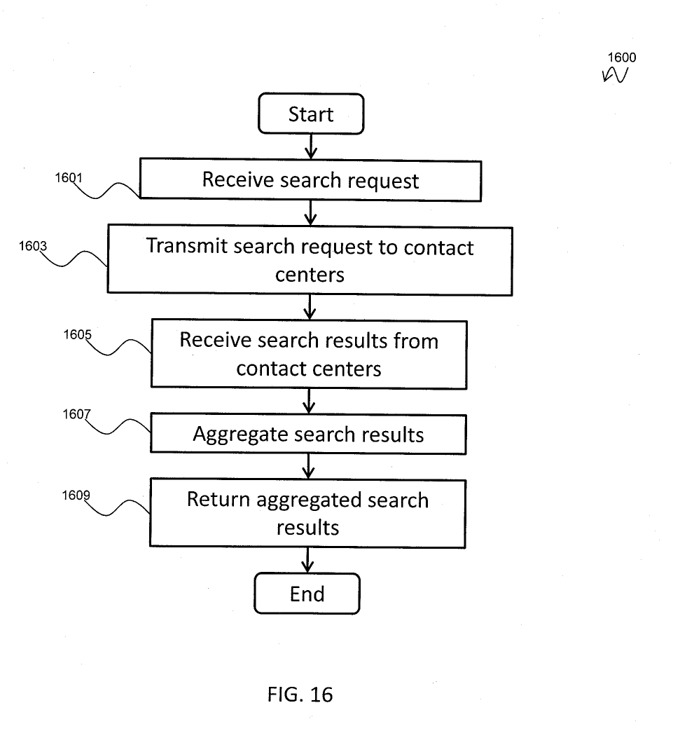

FIG. 16 is a flowchart illustrating a method for searching multiple contact centers according to one embodiment of the present invention. In operation 1601, the conversation assistance servers 110 receive a request from the client application 11 to search the transcripts of the user's calls for particular words or phrases (if allowed by the company's permissions or privacy policies). In some embodiments, the search can be performed across multiple different contact centers operated by different organizations that are compatible with the conversation assistance servers 110. As such, the search request is transmitted to these contact centers in operation 1603. These contact centers are ones which are accessible by the conversation assistance servers 110 and may be restricted to contact centers that the user has actually contacted in the past via the conversation assistance servers 110. In operation 1605, the conversation assistance servers 110 receive the search results from the various contact centers and aggregate those results in operation 1607. The aggregated search results are then returned to the requesting client application 11 in operation 1609.

In some embodiments, the search can also be performed to search all accessible interactions with various enterprises, including text chat transcriptions, emails, annotations and other notes regarding prior conversations. These interactions may be stored at the contact centers 80 and made available to the conversation assistance servers 110 using an application programming interface (API) or may be stored by the conversation assistance servers 110.

In still other embodiments the conversation assistance servers 110 include memory (e.g., dynamic memory or a persistent memory such as flash media and spinning hard disks) to store (e.g., cache) data for faster retrieval. For example, when searching for a keyword in all the previous calls the conversation assistance servers 110 may store an inverted index database mapping keywords to particular calls and call center names to avoid searching every call.

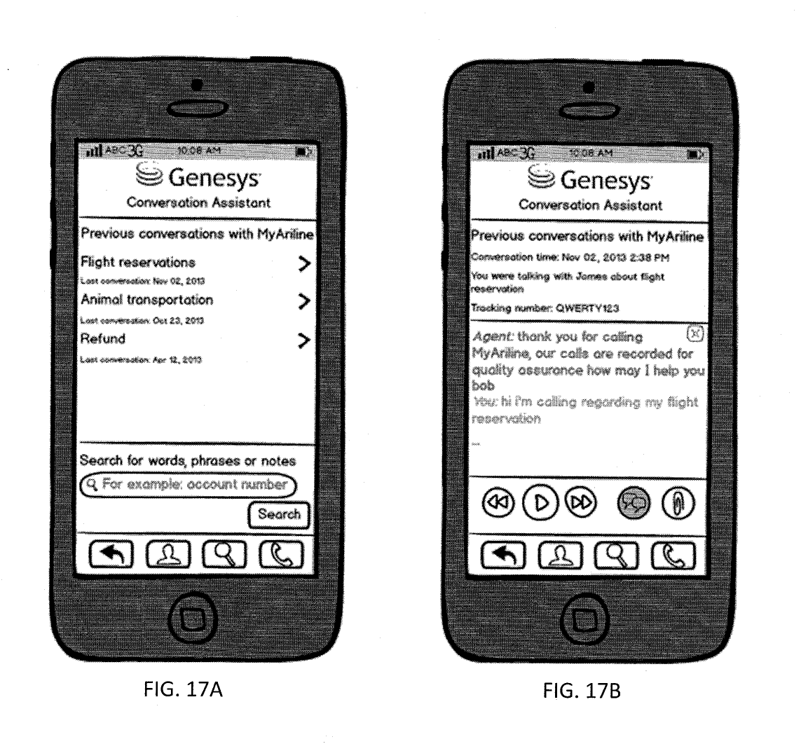

FIGS. 17A and 17B are screen shots of a user interface displayed by a client application running on a customer end user device for searching call recordings and viewing search results according to one embodiment of the present invention. FIG. 17A depicts a first screen that shows prior recorded calls and a text entry box for supplying a search term. FIG. 17B depicts search results along with playback controls (e.g., play/pause, rewind, fast forward, annotate, etc.).

### II. Vendor Relationship Management (VRM) for Customer Service

According to one embodiment, in addition or in lieu of organizations being in control of conversations and other interactions with organizations, enterprises, and vendors, the customers are also in control of data exchanged between the customer and different vendors, such as, for example, the same customer interacting with different companies. A customer management of the data associated with various organizations (or “vendors”) will be referred to herein as “vendor relationship management” or “VRM.”

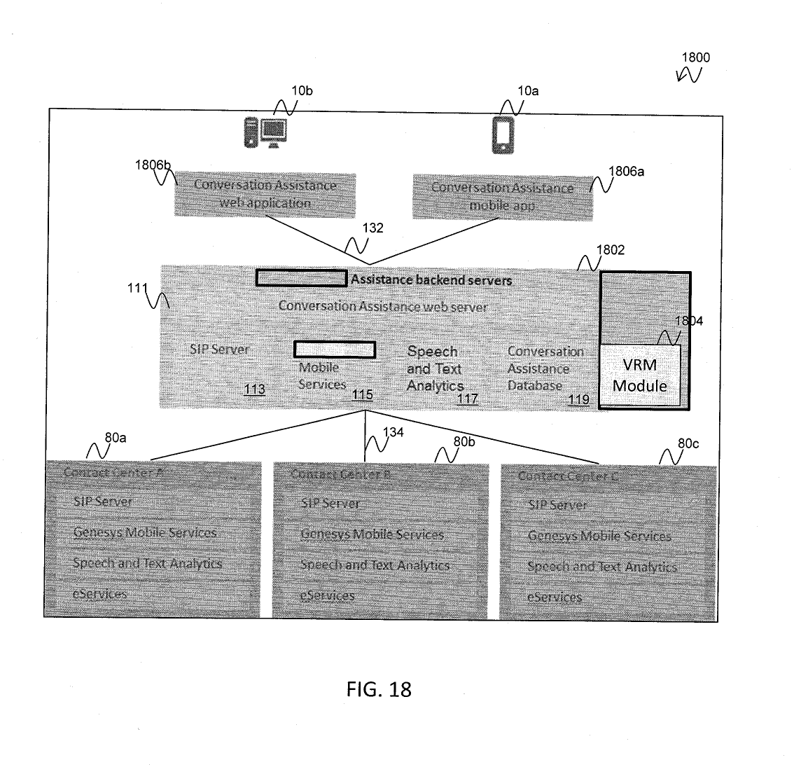

FIG. 18 is block diagram of a VRM system 1800 according to one embodiment of the invention. The VRM system includes a VRM assistance server 1802 coupled to the end user devices 10 and the various contact centers 80. The VRM assistance server 1802 may be similar to the conversation assistance server 110 of FIG. 2, and may provide substantially the same modules for providing conversation assistance as described with respect to FIG. 2. In addition to the modules for conversation assistance, the VRM assistance server 1802 also includes a VRM module 1804 for interacting with client applications 1806a, 1806b (collectively referred via reference 1806) and the vendors/contact centers 80 to allow the customer to manage relationships with the organizations (contact centers) 80, and to manage the data shared to and from the organizations (contact centers) 80.

According to one embodiment, the VRM module 1804 is configured to perform various functions in receiving and storing data supplied from client applications 1806 and from contact centers 80, and supplying the data to client applications 1806 and contact centers 80. During various interactions between the user and the contact centers 80, additional data may be generated and associated with the interactions. This additional data may include, for example, conversation transcripts, notes made by the user and/or an agent, test results, error reports, order histories, order tracking information, etc. and the additional data may be stored by the VRM module 1804. The additional data may also be shared between contact centers (e.g., of organizations, enterprises, and vendors) 80.

The data may be supplied to contact centers 80 and to client applications 1806 according to various rules as defined in “templates” that may be stored by the VRM module. As such, embodiments of the present invention can be used to “orchestrate” interactions and the flow of information between different vendors or enterprises providing services to a particular customer. This can be especially beneficial in situations where the services provided by the various enterprises complement one another or depend on one another.

In one embodiment of the present invention, a user may set up a client device 10 for use with the VRM system by installing an application 1806a (e.g., a mobile application) on a mobile device 10a accessing a web page (or web application) 1806b using a computer 10b. The client application 1806 may then request the user to enter some profile information, such as a name, address, phone number, and other identifying information.

According to one embodiment, the client applications 1806 may be similar to the client applications 11 of the above embodiments, except that the client applications 1806 of the present embodiment are enhanced with functionality to allow customers to manage relationships and data shared to and from the different contact centers. In this regard, the client applications 1806 provide a unified user interface for controlling the data that is shared with various vendors or enterprises.

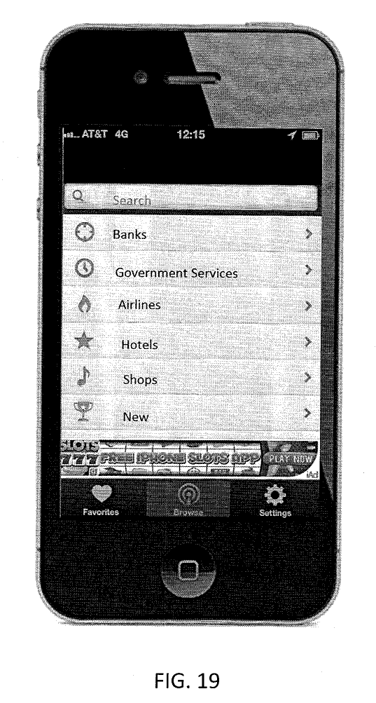

FIG. 19 is a screenshot of a user interface of a client application providing categories of vendors that are accessible through the client application 1806 along with a search box to allow a user to enter a search query to search for a particular enterprise according to one embodiment of the present invention. The user selects one or more enterprises to connect to, and additional information may be requested from the user for each of these enterprises. For example, in one embodiment, when adding an airline company, the client application 1806 may request that the user enter the frequent flyer number corresponding to that user's account. As another example, when adding a bank, an account number or a social security number may be requested. In some embodiments, entry of additional data is optional.

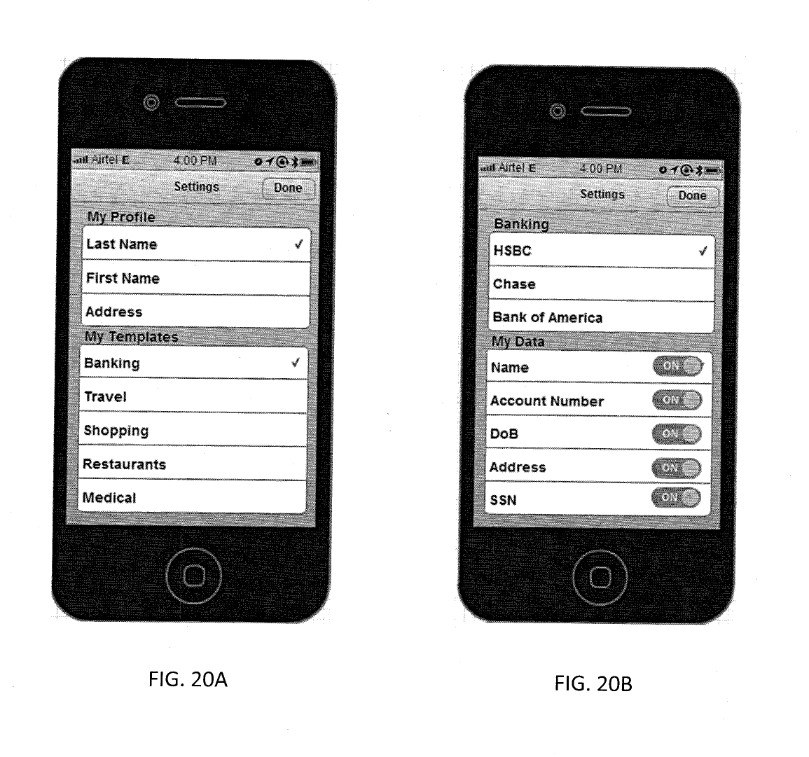

FIG. 20A is a screenshot of a user interface of a client application for entering personal profile data according to one embodiment of the present invention. As shown in FIG. 20A, profile information such as “Last Name,” “First Name,” and “Address” can be entered and stored (either locally on the device 10 or on the “cloud” in a server such as VRM module 1804). Various templates for vertical industries such as banking, travel, shopping, restaurants, and medical can also be provided, where the fields associated with the profile may differ based on the category of vendor (e.g., “restaurants” and “medical” may include field for food allergies, while “travel” and “shopping” may include payment information such as a credit card number). In some embodiments, multiple different profiles can be created and stored, where these different profiles may correspond to different users of the system (e.g., family members sharing a device), or which may correspond to personal versus business accounts.

FIG. 20B is a screenshot of a user interface of a client application for controlling the data that is to be supplied to particular vendors according to one embodiment of the present invention. As shown in FIG. 20, in one embodiment the client application 1806 allows a user to control the sharing of the data of individual fields (e.g., “Name,” “Account Number,” “Date of Birth,” “Address,” and “Social Security Number”) with high granularity on a field-by-field basis. As such, the user is allowed fine control over what data is provided to which vendor.

According to one embodiment, when a user initiates a call or other interaction with a contact center using the client application 1806 by selecting an accessible enterprise from a list of connected enterprises, profile information that has been marked as accessible by that enterprise is be automatically shared with the enterprise when the call is initiated, thereby simplifying the process of user authentication and reducing difficulties in communicating information between the user and an agent.

Furthermore, according to one embodiment of the present invention, storing profile information using the VRM system allows a user to update his or her information once (using the VRM system) and to have the updated information automatically propagated to all enterprises that are accessible by the VRM system. For example, after a user moves to a new home, the user may wish to update his or her mailing address with each enterprise that he or she deals with. In the past, updating the address generally would require contacting each enterprise to supply the enterprise with the new address. In contrast, according to one embodiment of the present invention, updating the address from within the client application 1806 causes the new address to be pushed to connected vendors that have access to the address fields of the user's profile.

According to one embodiment of the present invention, during initiation of the call, the client application 1806 may further provide an intelligent customer front door system that provides suggestions on how to route the call based on call reasons suggested by the user via the client application 1806. For example, the client application 1806 may provide a virtual assistant (implemented either locally on the end user device 10 or on a server 1802). The user may supply a call reason such as “I want to change my PIN” to the virtual assistant and the virtual assistant may then suggest a particular customer service department to handle such a request and assist in routing the call appropriately, thereby allowing the user to bypass at least some aspects of an IVR system. According to embodiment, this may be implemented in a manner substantially similar to that described above with respect to FIGS. 4 through 8.

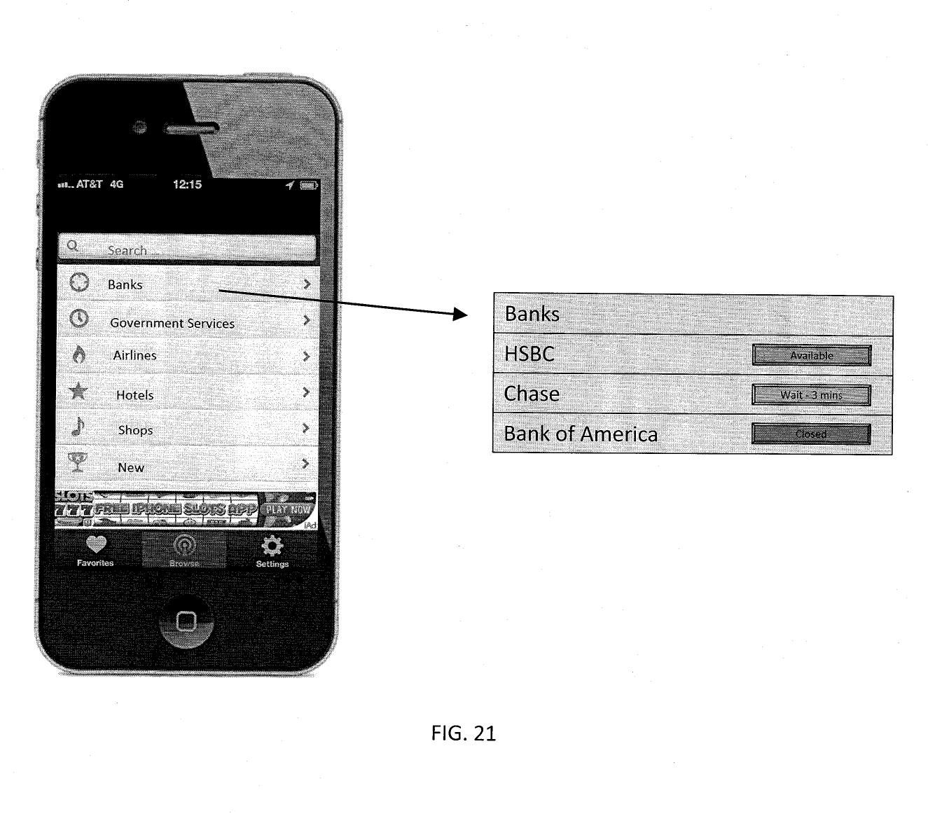

FIG. 21 is a screenshot of a user interface of a client application according to one embodiment of the present invention where, upon selecting an option to contact one or more connected enterprises belonging to the same category, the user interface displays current wait times for agents at those enterprises. As shown in the example of FIG. 21, the “Banks” category is selected and three banks that are connected to the user's VRM system are shown: “HSBC,” “Chase,” and “Bank of America,” which respectively have: an agent available now, a three minute wait for an agent, or no agent available due to being closed. These wait times and status indications can be retrieved by communicating with appropriate modules of the contact center 80. For example, in one embodiment, the VRM module 1804 communicates with the statistics servers 22 (see FIG. 1) of contact centers 80 to retrieve agent availability information at each of the contact centers 80.

According to one embodiment of the present invention, the VRM module 1804 assists in orchestrating complex tasks across multiple parties and vendors. For example, embodiments of the present invention may provide predefined templates for assisting a user in making travel arrangements, troubleshooting consumer products, and planning complex events (e.g., Valentine's Day celebrations).

For example, when making travel arrangements, a user may need to contact an airline company to book flight, a hotel to reserve a room, and a car rental company for transportation. The user may also want to make reservations at a local restaurant and purchase tickets to visit local attractions. This process generally requires contacting several different entities and manually communicating information to them. For example, after booking a flight, a user will generally also need to supply the flight information to the car rental company in order to identify which location the user would like to rent a car from and to provide vehicle pick-up and return times. In contrast, according to one embodiment of the present invention, information generated during the flight booking process (e.g., information about an issued ticket) can be automatically supplied to other enterprises (if the user chose to allow the other enterprises to have access to this information). For example, if the rental car company received the updated flight information through a VRM system according to embodiments of the present invention, it could automatically populate start and end times for the rental period. As another example, searches for restaurant reservations and tickets for events can be restricted to times between arrival and departure times of the flights.

Embodiments of the present invention may further perform sub-tasks to be plugged into the analysis of the scenarios. For example, the VRM system may automatically check to see if the user has friends who will be at the destination and try to arrange meetings, check to see if there are local franchises of a favorite restaurant chain in order to make reservations at these restaurants, and may check for sports events, concerts, or stage performances that will occur during the user's stay.

In some embodiments of the present invention, the users may use the client application 11 to upload data associated with prior calls with first agents of a first contact center to second agents of a second contact center of another enterprise. For example, a user having a problem with his smartphone first contacts the manufacturer of the phone to report a problem. The user may upload photographs, error logs, and other information stored on the phone to the contact center of the manufacturer. The interactions between the agent of the manufacturer and the user can be recorded and transcribed, and the transcripts may also be stored along with analysis by the agent. The package of information associated with the call may be stored at the conversation assistance servers 110 and/or at the end user device 10. During the call, the agent of the manufacturer may determine that the problem is not with the phone itself, but rather a configuration problem with the cellular carrier and, as such, may recommend contacting the carrier instead. As such, according to embodiments of the present invention, the user can upload the package of data associated with the first call (between the user and the manufacturer) to the agent of the cellular carrier, thereby simplifying the process of communicating the problem to the second agent (e.g., the carrier).

As another example, embodiments of the present invention may provide orchestration for tasks such as planning a complex event such as Valentine's Day celebrations, such as ordering flower delivery, booking transportation for the evening, making restaurant reservations, etc.

As described above, before, during, and after the interactions with the various enterprises, data is generated regarding the interactions and the plans that are made. According to one embodiment of the present invention, records regarding these interactions such as interaction history, personal notes, personal records, order history, etc. are stored and may be shared with other enterprises. The information may be shared using a standardized or uniform application programming interface (API) and protocol for cross-vendor transactions, such as the JSR 91 Trouble Ticket API.

According to one embodiment of the present invention, status changes at one enterprise can automatically generate notifications to other enterprises in related cases. Returning to the above example regarding travel arrangements, if, for example, a flight is delayed, then notifications may be automatically sent to the other enterprises that are involved in the related travel arrangements. As such, the car rental company may receive the notification of the delay and automatically adjust the car pick-up time, and the restaurant may receive the notification and automatically reserve a table at a later time, if available.

Embodiments of the present invention may be implemented either as a cloud based service or may be implemented on an end user device 10. For example, the various operations described above can be performed by a server 1802 that includes a VRM module 1804, or they can be performed by an application 1806 running on an end user device 10.

According to one embodiment of the present invention, the rules for conveying information from the user to vendors and between different vendors (including the propagation of information due to changes in conditions) can be defined by templates available to the user. The templates can be implemented using any of a variety of computer languages, such as State Chart eXtensible Markup Language (SCXML), JavaScript, Lisp, Python, Ruby, etc.

In some embodiments of the present invention, a user can create and customize templates using a template editor. In addition, in some embodiments, users can share templates with other users.

According to one embodiment of the present invention, a process for using a VRM system takes place on both an end user device and a server 1802. Initially, a user may trigger a new operation using the client application 1806 on the end user device 10. The triggering of the new operation triggers a new task in the server's orchestration service (e.g., the VRM module 1804). Based on the task triggered, a particular template is loaded, where the template includes operating rules (e.g., an SCXML script). The end user device 10 stores personal data and makes the data available to the server 1802 as needed. The VRM module 1804 may also consult the data collected from prior interactions, and supply relevant portions of the data from the prior interactions to various connected enterprises, in accordance with the operating rules. The VRM module 1804 may also load related sub-tasks (as described above) as specified by the operating rules.

However, embodiments of the present invention are not limited thereto. The various operations described above may be executed either entirely by the end user device 10, entirely by the server 1802, or various combinations thereof. For example, in some embodiments, the template is stored on and can be executed by the end user device 10 and the data generated during the interactions is stored on the end user device 10. As such, the end user device 10 can directly manage and supply data to various enterprises without assistance from a server 1802. As another example, in other embodiments of the present invention, the end user device 10 stores the generated data locally, but sends the data to various contact centers 80 via server 1802.

According to one embodiment of the present invention, a process for executing a template proceeds as follows: data associated with an interaction is received; a template associated with the data is identified; the various rules of the template are tested against the received data; matching rules of the template are executed, where the execution of a rule includes identifying at least one other enterprise that at least a portion of the received data is to be sent to; and sending the portion of the received data to the other enterprise.

In various embodiments of the present invention, a hybrid “automated” and “manual” sharing of data may be implemented. For example, instead of automatically sharing data between the user and enterprises and from one enterprise to another, the client application 1806 may show the user all of the data that will be shared prior to sharing the data, and the client application 1806 may allow the user to further refine which data is seen by the enterprise.

In some embodiments of the present invention, the client application 1806 also aggregates and provides access to data generated by devices owned or operated by the user. For example, an Internet-connected smoke detector may automatically generate notifications when smoke is detected. As another example, an Internet-connected washing machine may automatically generate notifications if it is running low on detergent and an Internet-connected refrigerator may generate notifications when its compressor is malfunctioning or when internal temperatures exceed a threshold level. According to some embodiments of the present invention, the data generated by the various devices can be aggregated by, for example, the client application 1806 running on the end user device 10 or by the VRM module 1804 on the server 1802, thereby providing a user with an aggregated view of the data generated by his or her appliances. Furthermore, data generated by the various devices and collected by a VRM system according to embodiments of the present invention can also be provided to agents at contact centers 80. For example, smoke detector information can be automatically provided to emergency services (e.g., 9-1-1 services), and appliance malfunction data can be automatically provided to agents when placing calls to request service.

In some embodiments of the present invention, access to the data generated by the devices can be controlled by the user in a manner similar to the control of individual fields of data of a user profile. In addition, in some embodiments of the present invention, the user is provided with notifications when data is to be communicated between a device and a vendor, where the notification provides the user with the ability to control whether or not the data is transmitted to the vendor and may include information about the way in which the information will be used by the vendor.

In some embodiments of the present invention, some or all of the functionality described above as being provided by the VRM module 1804 is provided by the client applications 1806 and performed by the end user devices 10.

According to some embodiments of the present invention, the conversation assistance servers 110 can also participate in orchestrating and/or federating information among various enterprises in order to allow communication of alerts and other data between different enterprises. For example, in one embodiment of the present invention, information from one enterprise (e.g., an airline) can automatically be transmitted to another enterprise (e.g., a car rental company) to assist in performing tasks (e.g., the car rental company can be provided with a flight number and arrival time, thereby simplifying the process of determining when the car will be rented and later returned).

Furthermore, information can automatically be generated to update other enterprises when conditions change at a first enterprise. For example, in one embodiment of the present invention, if a flight is delayed, then an alert can be automatically sent to the car rental company indicate that the reservation time should be moved back to a later time.

Although embodiments of the present invention are described above with respect to communications with contact centers, other aspects of communications with enterprises that may be conducted through or using VRM systems may also benefit from information exchange. For example, data can be generated during self-serve interactions (e.g., purchasing products or services via a website or interactions with a virtual agent) and this data can be supplied to self-serve interactions with other vendors.

Although embodiments of the present invention are described above with respect to interactions between individuals (or “users”) and one or more organizations (e.g., “vendors” or “enterprises”), embodiments of the present invention are not limited thereto. According to one embodiment of the present invention, data related to interactions with the “sharing economy” or “collaborative economy” or “peer-to-peer economy” in which individuals conduct transactions with one another using shared platforms are also captured by a VRM system. For example, when a user books a room in an individual's home through a collaborative economy room rental service (e.g., Craigslist® or Airbnb®), information is exchanged with the individual rather than with an agent at a contact center. As another example, when renting cars or receiving rides from individuals rather than organizations (e.g., using Getaround® and Lyft®), data is exchanged with the owners of the cars rather than agents at a contact center. However, the data exchanged with these individuals may similarly be captured and exchanged via a VRM system, e.g., a server 1802 and a VRM module 1806 or an end user device 10.

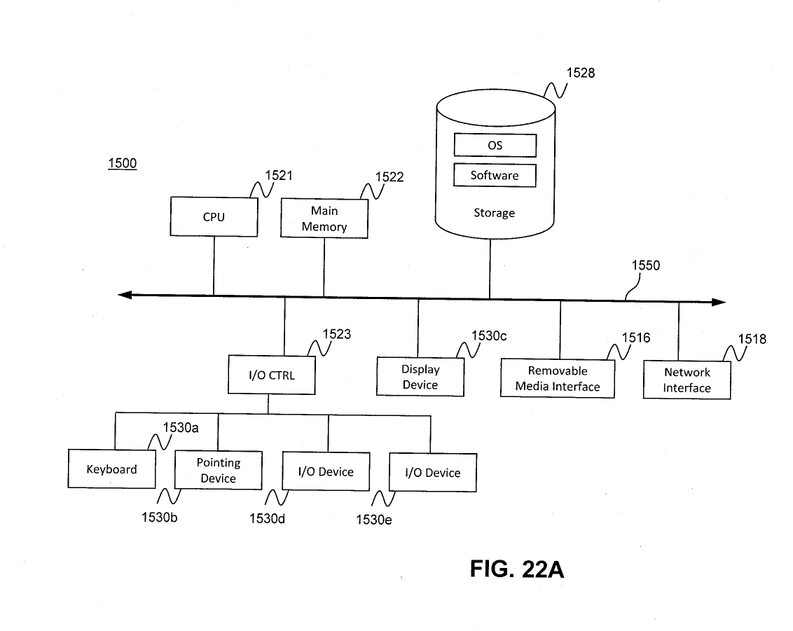

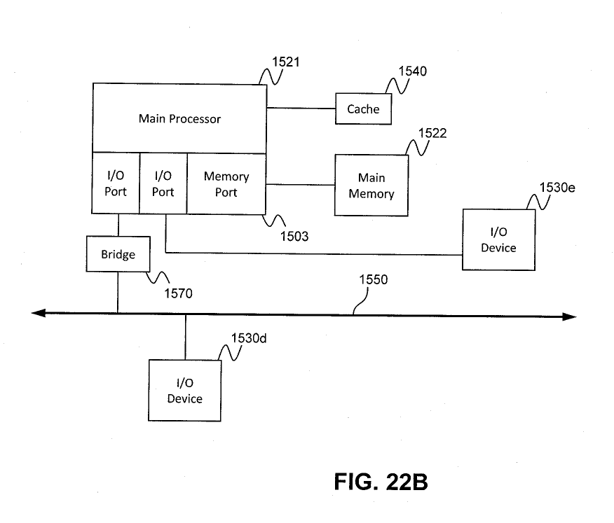

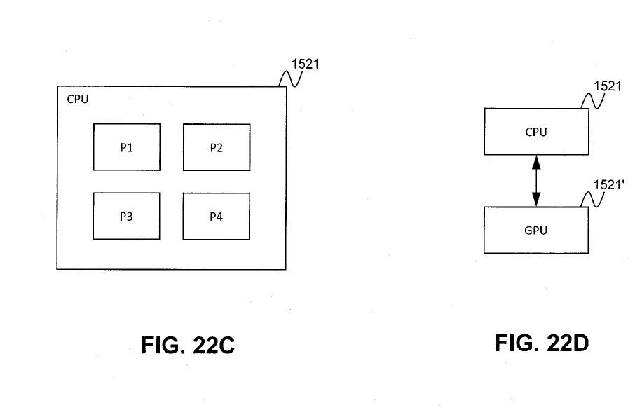

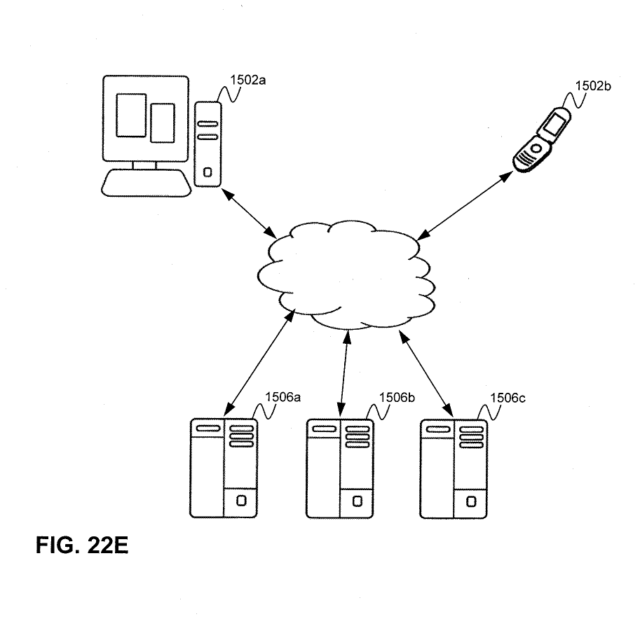

Each of the various servers in the contact center 80, the conversation assistance server 110, and the server 1802 may be a process or thread, running on one or more processors, in one or more computing devices 500 (e.g., FIG. 22A, FIG. 22B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers and other modules.

Each of the various servers, controllers, switches, and/or gateways in the afore-described figures may be a process or thread, running on one or more processors, in one or more computing devices 1500 (e.g., FIG. 22A, FIG. 22B), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that a computing device may be implemented via firmware (e.g. an application-specific integrated circuit), hardware, or a combination of software, firmware, and hardware. A person of skill in the art should also recognize that the functionality of various computing devices may be combined or integrated into a single computing device, or the functionality of a particular computing device may be distributed across one or more other computing devices without departing from the scope of the exemplary embodiments of the present invention. A server may be a software module, which may also simply be referred to as a module. The set of modules in the contact center may include servers, and other modules.

FIG. 22A and FIG. 22B depict block diagrams of a computing device 1500 as may be employed in exemplary embodiments of the present invention. Each computing device 1500 includes a central processing unit 1521 and a main memory unit 1522. As shown in FIG. 22A, the computing device 1500 may also include a storage device 1528, a removable media interface 1516, a network interface 1518, an input/output (I/O) controller 1523, one or more display devices 1530c, a keyboard 1530a and a pointing device 1530b, such as a mouse. The storage device 1528 may include, without limitation, storage for an operating system and software. As shown in FIG. 22B, each computing device 1500 may also include additional optional elements, such as a memory port 1503, a bridge 1570, one or more additional input/output devices 1530d, 1530e and a cache memory 1540 in communication with the central processing unit 1521. The input/output devices 1530a, 1530b, 1530d, and 1530e may collectively be referred to herein using reference numeral 1530.

The central processing unit 1521 is any logic circuitry that responds to and processes instructions fetched from the main memory unit 1522. It may be implemented, for example, in an integrated circuit, in the form of a microprocessor, microcontroller, or graphics processing unit (GPU), or in a field-programmable gate array (FPGA) or application-specific integrated circuit (ASIC). The main memory unit 1522 may be one or more memory chips capable of storing data and allowing any storage location to be directly accessed by the central processing unit 1521. As shown in FIG. 22A, the central processing unit 1521 communicates with the main memory 1522 via a system bus 1550. As shown in FIG. 22B, the central processing unit 1521 may also communicate directly with the main memory 1522 via a memory port 1503.

FIG. 22B depicts an embodiment in which the central processing unit 1521 communicates directly with cache memory 1540 via a secondary bus, sometimes referred to as a backside bus. In other embodiments, the central processing unit 1521 communicates with the cache memory 1540 using the system bus 1550. The cache memory 1540 typically has a faster response time than main memory 1522. As shown in FIG. 22A, the central processing unit 1521 communicates with various I/O devices 1530 via the local system bus 1550. Various buses may be used as the local system bus 1550, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 1530c, the central processing unit 1521 may communicate with the display device 1530c through an Advanced Graphics Port (AGP). FIG. 22B depicts an embodiment of a computer 1500 in which the central processing unit 1521 communicates directly with I/O device 1530e. FIG. 22B also depicts an embodiment in which local busses and direct communication are mixed: the central processing unit 1521 communicates with I/O device 1530d using a local system bus 1550 while communicating with I/O device 1530e directly.

A wide variety of I/O devices 1530 may be present in the computing device 1500. Input devices include one or more keyboards 1530a, mice, trackpads, trackballs, microphones, and drawing tablets. Output devices include video display devices 1530c, speakers, and printers. An I/O controller 1523, as shown in FIG. 22A, may control the I/O devices. The I/O controller may control one or more I/O devices such as a keyboard 1530a and a pointing device 1530b, e.g., a mouse or optical pen.

Referring again to FIG. 22A, the computing device 1500 may support one or more removable media interfaces 1516, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 1530 may be a bridge between the system bus 1550 and a removable media interface 1516.

The removable media interface 1516 may for example be used for installing software and programs. The computing device 1500 may further comprise a storage device 1528, such as one or more hard disk drives or hard disk drive arrays, for storing an operating system and other related software, and for storing application software programs. Optionally, a removable media interface 1516 may also be used as the storage device. For example, the operating system and the software may be run from a bootable medium, for example, a bootable CD.

In some embodiments, the computing device 1500 may comprise or be connected to multiple display devices 1530c, which each may be of the same or different type and/or form. As such, any of the I/O devices 1530 and/or the I/O controller 1523 may comprise any type and/or form of suitable hardware, software, or combination of hardware and software to support, enable or provide for the connection to, and use of, multiple display devices 1530c by the computing device 1500. For example, the computing device 1500 may include any type and/or form of video adapter, video card, driver, and/or library to interface, communicate, connect or otherwise use the display devices 1530c. In one embodiment, a video adapter may comprise multiple connectors to interface to multiple display devices 1530c. In other embodiments, the computing device 1500 may include multiple video adapters, with each video adapter connected to one or more of the display devices 1530c. In some embodiments, any portion of the operating system of the computing device 1500 may be configured for using multiple display devices 1530c. In other embodiments, one or more of the display devices 1530c may be provided by one or more other computing devices, connected, for example, to the computing device 1500 via a network. These embodiments may include any type of software designed and constructed to use the display device of another computing device as a second display device 1530c for the computing device 1500. One of ordinary skill in the art will recognize and appreciate the various ways and embodiments that a computing device 1500 may be configured to have multiple display devices 1530c.

A computing device 1500 of the sort depicted in FIG. 22A and FIG. 22B may operate under the control of an operating system, which controls scheduling of tasks and access to system resources. The computing device 1500 may be running any operating system, any embedded operating system, any real-time operating system, any open source operating system, any proprietary operating system, any operating systems for mobile computing devices, or any other operating system capable of running on the computing device and performing the operations described herein.

The computing device 1500 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 1500 may have different processors, operating systems, and input devices consistent with the device.

In other embodiments the computing device 1500 is a mobile device, such as a Java-enabled cellular telephone or personal digital assistant (PDA), a smart phone, a digital audio player, or a portable media player. In some embodiments, the computing device 1500 comprises a combination of devices, such as a mobile phone combined with a digital audio player or portable media player.

As shown in FIG. 22C, the central processing unit 1521 may comprise multiple processors P1, P2, P3, P4, and may provide functionality for simultaneous execution of instructions or for simultaneous execution of one instruction on more than one piece of data. In some embodiments, the computing device 1500 may comprise a parallel processor with one or more cores. In one of these embodiments, the computing device 1500 is a shared memory parallel device, with multiple processors and/or multiple processor cores, accessing all available memory as a single global address space. In another of these embodiments, the computing device 1500 is a distributed memory parallel device with multiple processors each accessing local memory only. In still another of these embodiments, the computing device 1500 has both some memory which is shared and some memory which may only be accessed by particular processors or subsets of processors. In still even another of these embodiments, the central processing unit 1521 comprises a multicore microprocessor, which combines two or more independent processors into a single package, e.g., into a single integrated circuit (IC). In one exemplary embodiment, depicted in FIG. 22D, the computing device 1500 includes at least one central processing unit 1521 and at least one graphics processing unit 1521′.

In some embodiments, a central processing unit 1521 provides single instruction, multiple data (SIMD) functionality, e.g., execution of a single instruction simultaneously on multiple pieces of data. In other embodiments, several processors in the central processing unit 1521 may provide functionality for execution of multiple instructions simultaneously on multiple pieces of data (MIMD). In still other embodiments, the central processing unit 1521 may use any combination of SIMD and MIMD cores in a single device.

A computing device may be one of a plurality of machines connected by a network, or it may comprise a plurality of machines so connected. FIG. 22E shows an exemplary network environment. The network environment comprises one or more local machines 1502a, 1502b (also generally referred to as local machine(s) 1502, client(s) 1502, client node(s) 1502, client machine(s) 1502, client computer(s) 1502, client device(s) 1502, endpoint(s) 1502, or endpoint node(s) 1502) in communication with one or more remote machines 1506a, 1506b, 1506c (also generally referred to as server machine(s) 1506 or remote machine(s) 1506) via one or more networks 1504. In some embodiments, a local machine 1502 has the capacity to function as both a client node seeking access to resources provided by a server machine and as a server machine providing access to hosted resources for other clients 1502a, 1502b. Although only two clients 1502 and three server machines 1506 are illustrated in FIG. 22E, there may, in general, be an arbitrary number of each. The network 1504 may be a local-area network (LAN), e.g., a private network such as a company Intranet, a metropolitan area network (MAN), or a wide area network (WAN), such as the Internet, or another public network, or a combination thereof.

The computing device 1500 may include a network interface 1518 to interface to the network 1504 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 1500 communicates with other computing devices 1500 via any type and/or form of gateway or tunneling protocol such as Secure Socket Layer (SSL) or Transport Layer Security (TLS). The network interface 1518 may comprise a built-in network adapter, such as a network interface card, suitable for interfacing the computing device 1500 to any type of network capable of communication and performing the operations described herein. An I/O device 1530 may be a bridge between the system bus 1550 and an external communication bus.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. An apparatus comprising:
a processor; and
memory, wherein the memory has stored thereon instructions that, when executed by the processor, cause the processor to execute a client application, the client application being configured to:
identify a plurality of parameters prior to initiating an interaction request;
transmit the interaction request to a server to initiate an interaction with a contact center, the interaction request comprising the plurality of parameters;
display a graphical user interface;
receive a command via the graphical user interface;
transmit, during the interaction, the command to a conversation assistance system in communication with a server of the contact center, the server of the contact server managing interactions with the contact center, the command controlling an aspect of the interaction via the conversation assistance system; and
receive information regarding the interaction after termination of the interaction with the contact center.

2. The apparatus of claim 1, wherein the parameters comprise user authentication information.

3. The apparatus of claim 1, wherein the parameters comprise one or more agent identifiers corresponding to agents at the contact center.

4. The apparatus of claim 3, wherein the memory further has stored instructions thereon that, when executed by the processor, cause the processor to receive an estimated wait time associated with the one or more agent identifiers.

5. The apparatus of claim 1, wherein the memory further has stored instructions thereon that, when executed by the processor, cause the processor to:
display one or more inferred call reasons, the inferred call reasons being computed based on at least one of a prior call, a prior interaction with the contact center, and a web browsing history; and
to transmit to the contact center a selected call reason from among the inferred call reasons.

6. The apparatus of claim 5, wherein at least one of the inferred call reasons is computed by:
automatically recognizing speech within the prior call to generate recognizer output;
detecting phrases within the recognizer output, the phrases corresponding to at least one topic; and
identifying the at least one topic as the at least one inferred call reason.

7. The apparatus of claim 5, wherein the interaction is routed to an agent of the contact center in accordance with the selected call reason.

8. The apparatus of claim 1, wherein the interaction is routed to an agent of the contact center in accordance with at least one of the parameters.

9. The apparatus of claim 1, wherein the interaction comprises a voice communication channel.

10. The apparatus of claim 1, wherein the memory further has stored instructions thereon that, when executed by the processor, cause the processor to:
display a web page; and
transmit a URL of the web page or a portion of the web page.

11. The apparatus of claim 1, wherein the memory further has stored instructions thereon that, when executed by the processor, cause the processor to: receive, from the contact center, content associated with content of the interaction.

12. The apparatus of claim 1, wherein the memory further has stored instructions thereon that, when executed by the processor, cause the processor to: transmit, to the contact center, content associated with content of the interaction.

13. (canceled)

14. The apparatus of claim 1, wherein the command comprises a request to transfer the interaction from a first human agent of the contact center to a second human agent of the contact center.

15. The apparatus of claim 1, wherein the command comprises a complaint regarding the interaction.

16. The apparatus of claim 1, wherein the memory further has stored instructions thereon that, when executed by the processor, cause the processor to: receive, from the contact center, data associated with the interaction, the data comprising at least one of a shared screen, a pushed web page, and a uniform resource locator.

17. The apparatus of claim 1, wherein the memory further has stored instructions thereon that, when executed by the processor, cause the processor to: transmit, to the contact center, data associated with the interaction, the data comprising at least one of a shared screen, an image, a uniform resource locator, and a log file.

18. The apparatus of claim 1, wherein the information regarding the interaction is a call receipt.

19. The apparatus of claim 1, wherein the information regarding the interaction is a recording of the interaction.

20. An apparatus comprising:
a processor; and
memory, wherein the memory has stored thereon instructions that, when executed by the processor, cause the processor to:
identify a plurality of parameters prior to initiating an interaction request;
transmit the interaction request to a server to initiate an interaction with a contact center, the interaction request comprising the plurality of parameters; and
receive information regarding the interaction after termination of the interaction with the contact center,
wherein the information regarding the interaction is a recording of the interaction, and
wherein the memory further has stored instructions thereon that, when executed by the processor, cause the processor to transmit:
a first annotation associated with the recording of the interaction, the first annotation comprising first text and a first time index; and
a second annotation associated with the recording of the interaction, the second annotation comprising second text and a second time index, the second text being different from the first text and the second time index being different from the first time index.

21. The apparatus of claim 20, wherein the memory further has stored instructions thereon that, when executed by the processor, cause the processor to:
mark the annotation as private to a user; and
mark the annotation as viewable by the contact center.

22. The apparatus of claim 1, wherein the memory further has stored instructions thereon that, when executed by the processor, cause the processor to store a recording of the interaction.

23. The apparatus of claim 22, wherein the memory further has stored instructions thereon that, when executed by the processor, cause the processor to store an annotation associated with the recording of the interaction, the annotation comprising text and a time index.

24. The apparatus of claim 1, wherein the information regarding the interaction comprises a result of a search of a transcript of the interaction.

25. An apparatus comprising:
a processor; and
memory, wherein the memory has stored thereon instructions that, when executed by the processor, cause the processor to execute a client application, the client application being configured to:
identify a plurality of parameters prior to initiating an interaction request;
transmit the interaction request to a server to initiate an interaction with a contact center, the interaction request comprising the plurality of parameters;
display a graphical user interface;
receive information regarding the interaction after termination of the interaction with the contact center, wherein the information regarding the interaction comprises an aggregated result of a search of a first transcript of the interaction with the contact center and a second transcript of a second interaction with another contact center different from the contact center; and
display the search result on the graphical user interface.

26. The apparatus of claim 1, wherein the memory further has stored instructions thereon that, when executed by the processor, cause the processor to search a transcript of the interaction.

27. The apparatus of claim 1, wherein the memory further has stored instructions thereon that, when executed by the processor, cause the processor to search a first transcript of the interaction with the contact center and a second transcript of a second interaction with another contact center different from the contact center.

28. A method for processing interactions, the method comprising:
identifying, on a processor executing a client application, a plurality of parameters prior to initiating an interaction request;
transmitting, by the client application, the interaction request to a server to initiate an interaction with a contact center, the interaction request comprising the plurality of parameters;
displaying, by the client application, a graphical user interface;
receiving, by the client application, a command via the graphical user interface;
transmitting, by the client application, during the interaction, the command to a conversation assistance system in communication with a server of the contact center, the server of the contact server managing interactions with the contact center, the command controlling an aspect of the interaction via the conversation assistance system; and
receiving, by the client application, information regarding the interaction after termination of the interaction with the contact center.

29. The method of claim 28, wherein the information regarding the interaction comprises a result of a search of a transcript of the interaction.
